(19) United States
(12) Patent Application Publication
(10) Pub. No.: US 2010/0232815 A1
(43) Pub. Date: Sep. 16, 2010

(54) TONER CARTRIDGE CAPABLE OF DETECTING RESIDUAL AMOUNT OF TONER STORED THEREIN

(76) Inventor: Chunhua ZHENG, Qitaihe Shi (CN)

Correspondence Address: RABIN & Berdo, PC, 1101 14TH STREET, NW, SUITE 500, WASHINGTON, DC, 20005, US

(21) Appl. No.: 12/402,774

(22) Filed: Mar. 12, 2009

(51) Int. Cl. G03G 15/08

(52) U.S. Cl. 399/27; 399/254

(57) ABSTRACT

The present invention provides a toner cartridge which comprises: a hopper for storing toner therein; a stirring means comprising a first paddle connected to a driving source and adapted to rotate in the hopper, and a second paddle connected to the first paddle by means of an elastic member, the stirring means being adapted to stir the toner in the hopper by the first paddle and the second paddle; and a detection means comprising an encoder having a first slit and a second slit formed thereon for transmitting light therethrough, the second slit having a width different from that of the first slit, an encoder gear connected to the second paddle for driving the encoder, and a sensor 590 mounted at a sensor reference position for outputting a first signal corresponding to the first slit and a second signal corresponding to the second slit, whereby the sensor detects a time delay of the second signal with respect to the first signal to measure the residual amount of the toner. The present invention also provides an electrophotographic image forming apparatus including the toner cartridge.

### BACKGROUND OF THE INVENTION

(a) Field of the Invention

The present invention relates to a toner cartridge and an image forming apparatus including the same, and more particularly, to a toner cartridge capable of detecting the residual amount of toner stored therein, and an electrophotographic image forming apparatus including the same.

(b) Background Art

An electrophotographic image forming apparatus is configured such that an electrostatic latent image corresponding to a desired image formed in advance on a photosensitive body is developed as a toner image every color and the developed image is transferred and fixed onto a printing medium such as a sheet of transfer paper to form the desired image. The toner is stored in a toner cartridge, and when the stored toner is used up, the spent toner cartridge is replaced with a new one.

In this case, all the printing operations are stopped until the replacement of the toner cartridge is completed. Thus, in the case where a large amount of prints or a real-time printing is required, much loss occurs when printing is delayed due to consumption of the toner. If the spent toner cartridge is replaced immediately upon the depletion of the toner, such a loss can be reduced. However, in order to reduce the time required to replace the toner cartridge, the residual amount of toner should be, first of all, detected.

A conventional technology for detecting a toner residual amount will be discussed hereinafter.

First, in a toner residual amount detecting device using an optical technique, light is illuminated through a hopper having a toner contained therein and the toner interrupts the light until the level of the toner drops to below a predetermined level. At this time, if the level of the toner drops to below the predetermined level, the illuminated light is detected by an optical sensor. However, this method has a drawback in that it is possible to merely determine whether or not the level of the toner has dropped to below the predetermined level, but the residual amount of toner cannot be accurately measured.

In the meantime, as one example of an apparatus for mechanically detecting a toner residual amount of toner, U.S. Pat. No. 4,003,258 discloses a method in which the position of a toner paddle with respect to a driving shaft of the paddle is detected using two disks. The paddle drops freely from a position where the paddle reaches the uppermost portion. When the paddle comes into close contact with the toner surface, the free dropping of the paddle is stopped. In this case, when the angle at which the paddle drops is larger than a predetermined angle, the toner consumption state is determined to be a low toner state.

In addition, U.S. Pat. No. 5,216,462 discloses a system in which a spring interconnects two disks and a phase change of the disks indicates a load torque of a toner paddle.

However, the above U.S. patents entails a problem in that the driving characteristics of a mechanism is non-linear, resulting in unstable detection of a toner residual amount, two disks are used to detect the position of the paddle, making the structure of the apparatus complicated, and complex structures are densely disposed a narrow space, making a fault risk high. Further, the above U.S. patents has a limitation in detection capability in that detection sensitivity for a consecutive toner level detection is lowered or only whether or not the toner residual amount excesses a single specific toner level can be determined.

Meanwhile, the toner particles stored in the toner cartridge are agglomerated near a toner supply roller. Alternatively, if the amount of toner being supplied to the toner supply roller by a stirring means is excessive, the operation characteristics of the toner supply roller and a developing roller may be deteriorated. Therefore, a means for suppressing this is required.

Furthermore, there is also a need for a means capable of controlling a driving load and a driving timing so as to prevent a load for driving the stirring means and an additional stirring means from adversely affecting the operation characteristics of the toner cartridge.

The information disclosed in this background of the invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, the present invention has been made in an effort to solve the aforementioned problems occurring in the prior art, and it is an object of the present invention to provide a toner cartridge which can detect a change in the output period of a detection means due to a load torque of toner varying depending on a toner residual amount so as to measure the toner residual amount over the consecutive toner levels with sufficient detection sensitivity, as well as which can reduce non-linearity of the detection means, can implement a stirring means and a detection means in a simple structure, and can improve cost and reliability of the toner residual amount measurement, and an electrophotographic image forming apparatus including the same.

Another object of the present invention is to provide a toner cartridge which can re-stirs toner between a stirring means and a supply roller so as to prevent deterioration of the characteristics of a developing roller and the supply roller, and includes an auxiliary stirring means driven in a state where it does not greatly affect a driving load of the toner cartridge.

To accomplish the above object, in one aspect, the present invention provides a toner cartridge, comprising: a hopper for storing toner therein; a stirring means for stirring the toner in the hopper, the stirring means comprising a first paddle connected to a driving source and adapted to rotate in the hopper, a second paddle adapted to receive a load contact torque larger than a load contact torque acting on the first paddle, and an elastic member for elastically connecting the second paddle to the first paddle; and a detection means for detecting a time delay to measure the residual amount of the toner based on the fact that deformation of the elastic member according to the toner residual amount causes the time delay in the rotation angle of the second paddle.

Also, the present invention provides a toner cartridge comprising: a hopper for storing toner therein; a stirring means comprising a first paddle connected to a driving source and adapted to rotate in the hopper, and a second paddle connected to the first paddle by means of an elastic member, the stirring means being adapted to stir the toner in the hopper by the first paddle and the second paddle; and a detection means comprising an encoder having a first slit and a second slit formed thereon for transmitting light therethrough, the second slit having a width different from that of the first slit, an encoder gear connected to the second paddle for driving the encoder, and a sensor mounted at a sensor reference position for outputting a first signal corresponding to the first slit and a second signal corresponding to the second slit, whereby the sensor detects a time delay of the second signal with respect to the first signal to measure the residual amount of the toner.

Meanwhile, the present invention provides an electrophotographic image forming apparatus including a detachable toner cartridge, wherein the toner cartridge comprises: a hopper for storing toner therein; a stirring means comprising a first paddle connected to a driving source and adapted to rotate in the hopper, and a second paddle connected to the first paddle by means of an elastic member, the stirring means being adapted to stir the toner in the hopper by the first paddle and the second paddle; and a detection means comprising an encoder having a first slit and a second slit formed thereon for transmitting light therethrough, the second slit having a width different from that of the first slit, an encoder gear connected to the second paddle for driving the encoder, and a sensor mounted at a sensor reference position for outputting a first signal corresponding to the first slit and a second signal corresponding to the second slit, whereby the sensor detects a time delay of the second signal with respect to the first signal to measure the residual amount of the toner.

To accomplish the above object, in another aspect, the present invention provides a toner cartridge comprising: a developing roller for allowing an electrostatic latent image formed in advance on a photosensitive body to be developed as a toner image; a supply roller for supplying the toner to the developing roller; a stirring means for stirring the toner stored in the hopper to convey the stirred toner to the supply roller; an auxiliary stirring means comprising an auxiliary stirring roller disposed between the stirring means and the supply roller for re-stirring the toner being fed from the stirring means, a ratchet for rotating the auxiliary stirring roller, and a pawl movement member including a pawl adapted to tooth-engage with the ratchet so that it is linearly moved together with the pawl to rotate the ratchet, wherein the pawl movement member is linearly be moved by being connected to the stirring means to cause the auxiliary stirring roller to be driven.

In addition, the present invention provides a toner cartridge comprising: a developing roller for allowing an electrostatic latent image formed in advance on a photosensitive body to be developed as a toner image; a supply roller for supplying the toner to the developing roller; a stirring means for stirring the toner stored in the hopper to convey the stirred toner to the supply roller; an auxiliary stirring means comprising an auxiliary stirring roller disposed between the stirring means and the supply roller for re-stirring the toner being fed from the stirring means, a roller gear for rotating the auxiliary stirring roller, and an intermittent gear for intermittently driving the roller gear, wherein the intermittent gear rotates by being connected to the stirring means to cause the auxiliary stirring roller to be driven.

Further, the present invention provides a toner cartridge comprising: a developing roller for allowing an electrostatic latent image formed in advance on a photosensitive body to be developed as a toner image; a supply roller for supplying the toner to the developing roller; a stirring means for stirring the toner stored in the hopper to convey the stirred toner to the supply roller; an auxiliary stirring means comprising an auxiliary stirring roller disposed between the stirring means and the supply roller for re-stirring the toner being fed from the stirring means, a first link for rotating the auxiliary stirring roller, a second link connected at one side thereof to the first link and having an eccentric cam insertion portion formed at the other side thereof, and an eccentric cam rotatably inserted into the eccentric cam inserting portion, wherein the eccentric cam rotates by being connected to the stirring means to cause the auxiliary stirring roller to be driven.

Moreover, the present invention provides a toner cartridge comprising: a developing roller for allowing an electrostatic latent image formed in advance on a photosensitive body to be developed as a toner image; a supply roller for supplying the toner to the developing roller; a stirring means for stirring the toner stored in the hopper to convey the stirred toner to the supply roller; and an auxiliary stirring means comprising an auxiliary stirring wire portion disposed between the stirring means and the supply roller for re-stirring the toner being fed from the stirring means, and a wire roller gear for rotating the auxiliary stirring wire portion, wherein the auxiliary stirring wire portion comprises an auxiliary stirring wire stirrer, wherein the auxiliary stirring wire stirrer comprises an auxiliary stirring wire body connector connected to the wire roller gear, and an auxiliary stirring wire body connected to the auxiliary stirring wire body connector, the lengthwise central axis of the auxiliary stirring wire body being spaced apart from the rotation center of the wire roller gear, so that the auxiliary stirring wire body re-stirs the toner.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a side cross-sectional view schematically illustrating the internal construction of an electrophotographic image forming apparatus including a toner cartridge according to the present invention;

FIG. 2 is a perspective view illustrating an outer appearance of a toner cartridge according to the present invention;

FIG. 3 is a front view of FIG. 2;

FIG. 4 is a perspective view illustrating the internal construction of a toner cartridge according to the present invention;

FIG. 5 is a side cross-sectional view illustrating a stirring means and a detection means in the case where there is no toner residual amount in a toner cartridge and a first paddle is in an initial position according to the present invention;

FIG. 6 is a perspective view illustrating the stirring means and the detection means of FIG. 5;

FIG. 7 is a side cross-sectional view illustrating a stirring means and a detection means in the case where there is no toner residual amount in a toner cartridge and a first paddle is in a 90 degree-rotated position according to the present invention;

FIG. 8 is a perspective view illustrating the stirring means and the detection means of FIG. 7;

FIG. 9 is a side cross-sectional view illustrating a stirring means and a detection means in the case where there is no toner residual amount in a toner cartridge and a first paddle is in a 180 degree-rotated position according to the present invention;

FIG. 10 is a perspective view illustrating the stirring means and the detection means of FIG. 9;

FIG. 11 is a side cross-sectional view illustrating a stirring means and a detection means in the case where there is no toner residual amount in a toner cartridge and a first paddle is in a 270 degree-rotated position according to the present invention;

FIG. 12 is a perspective view illustrating the stirring means and the detection means of FIG. 11;

FIG. 13 is a side cross-sectional view illustrating a stirring means and a detection means in the case where there is a certain toner residual amount in a toner cartridge and a first paddle is in an initial position according to the present invention;

FIG. 14 is a perspective view illustrating the stirring means and the detection means of FIG. 13;

FIG. 15 is a side cross-sectional view illustrating a stirring means and a detection means in the case where there is a certain toner residual amount in a toner cartridge and a first paddle is in a 90 degree-rotated position according to the present invention;

FIG. 16 is a perspective view illustrating the stirring means and the detection means of FIG. 15;

FIG. 17 is a side cross-sectional view illustrating a stirring means and a detection means in the case where there is a certain toner residual amount in a toner cartridge and a first paddle is in a 180 degree-rotated position according to the present invention;

FIG. 18 is a perspective view illustrating the stirring means and the detection means of FIG. 17;

FIG. 19 is a side cross-sectional view illustrating a stirring means and a detection means in the case where there is a certain toner residual amount in a toner cartridge and a first paddle is in a 270 degree-rotated position according to the present invention;

FIG. 20 is a perspective view illustrating the stirring means and the detection means of FIG. 19;

FIG. 21 is a side cross-sectional view illustrating a stirring means and a detection means in the case where there is a certain toner residual amount in a toner cartridge and a first paddle is in a 330 degree-rotated position according to the present invention;

FIG. 22 is a perspective view illustrating the stirring means and the detection means of FIG. 21;

FIGS. 23 and 24 are views illustrating a state where an encoder returns to its initial position;

FIGS. 25a and 25b are explanatory views sequentially illustrating the positions of a stirring means and a detection means according to a rotation angle of a first paddle in the case where there is a certain toner residual amount in a toner cartridge;

FIG. 26 is a timing chart showing an output signal of a sensor in the case where there is no toner residual amount in a toner cartridge;

FIG. 27 is a timing chart showing an output signal of a sensor in the case where there is a certain toner residual amount in a toner cartridge;

FIG. 28 is a front view illustrating a pawl member of the present invention;

FIG. 29 is a perspective view illustrating the internal construction of a toner cartridge including an auxiliary stirring means of a first embodiment according to the present invention;

FIGS. 30 and 31 are side cross-sectional views illustrating the operation of the auxiliary stirring means of the first embodiment according to the present invention;

FIG. 32 is a perspective view illustrating the internal construction of a toner cartridge including an auxiliary stirring means of a second embodiment according to the present invention;

FIGS. 33 and 34 are side cross-sectional views illustrating the operation of the auxiliary stirring means of the second embodiment according to the present invention;

FIG. 35 is a perspective view illustrating the internal construction of a toner cartridge including an auxiliary stirring means of a third embodiment according to the present invention;

FIGS. 36 to 39 are side cross-sectional views illustrating the operation of the auxiliary stirring means of the third embodiment according to the present invention;

FIG. 40 is an outer side view illustrating the internal construction of a toner cartridge including an auxiliary stirring means of a fourth embodiment according to the present invention;

FIG. 41 is a partial side cross-sectional view schematically illustrating the auxiliary stirring means of the fourth embodiment according to the present invention;

FIG. 42 is a partially cut perspective view schematically illustrating the auxiliary stirring means of the fourth embodiment according to the present invention; and

FIG. 43 is a partially exploded perspective view schematically illustrating the auxiliary stirring means of the fourth embodiment according to the present invention.

### DETAILED DESCRIPTION

Reference will now be made in detail to the preferred embodiment of the present invention, examples of which are illustrated in the drawings attached hereinafter, wherein like reference numerals refer to like elements throughout. In the detailed description of the preferred embodiments of the present invention, the size, the shape or the like of constituent elements may be exaggeratedly shown in the drawings for the sake of clarity and convenience of explanation. In addition, the terms defined specifically in consideration of the construction and operation of the present invention may vary depending on the intension or practice of a user, an operator and the like. The definition of such terms should be made according to overall disclosures set forth herein.

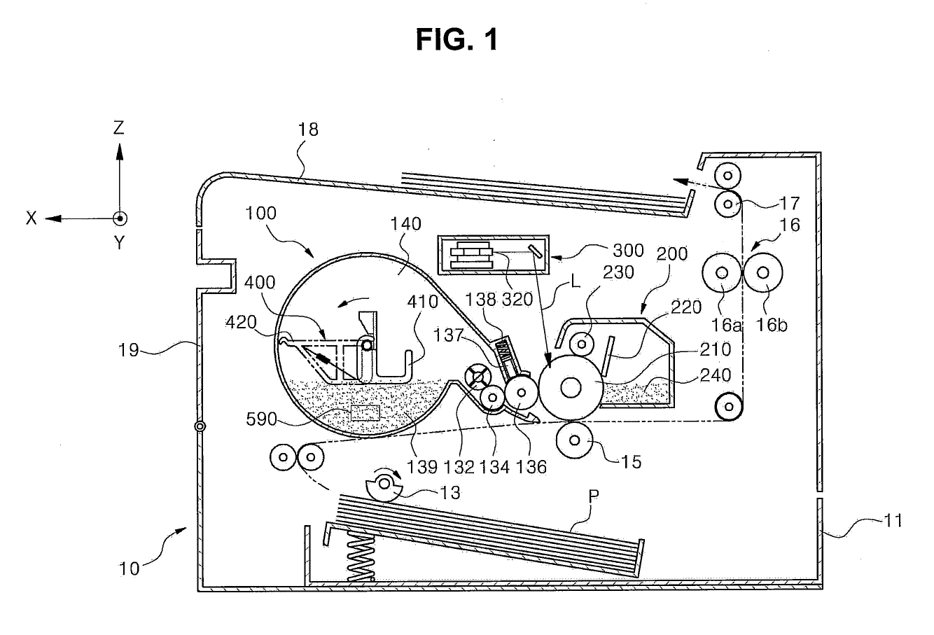

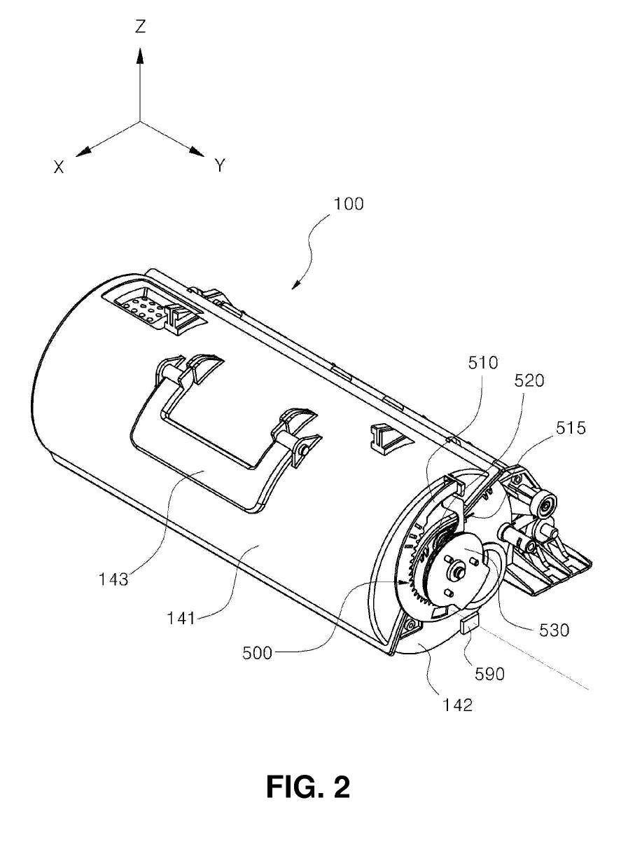

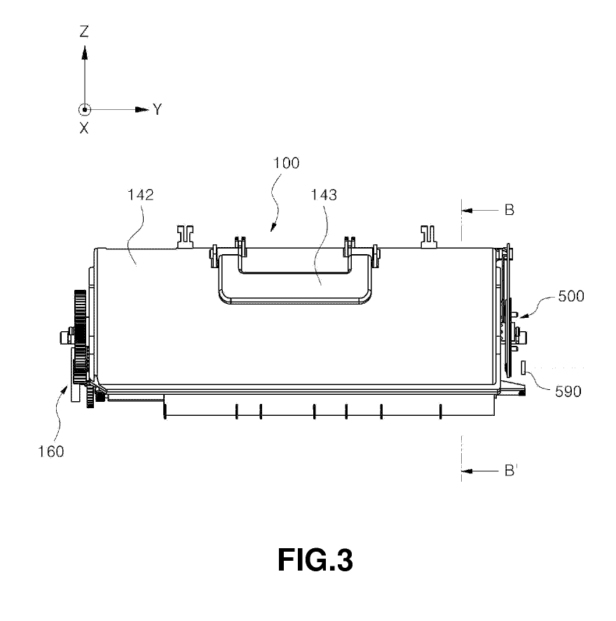

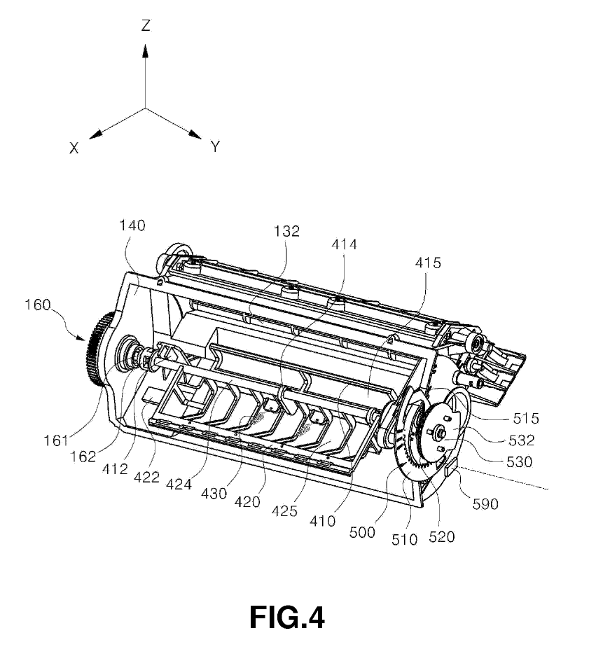

FIG. 1 is a side cross-sectional view schematically illustrating the internal construction of an electrophotographic image forming apparatus including a toner cartridge 100 according to the present invention, FIG. 2 is a perspective view illustrating an outer appearance of a toner cartridge 100 according to the present invention, FIG. 3 is a front view of FIG. 2, and FIG. 4 is a perspective view illustrating the internal construction of a toner cartridge 100 according to the present invention.

An electrophotographic image forming apparatus, a toner cartridge 100, a stirring means 400 and a detection means 500 according to the present invention will be described hereinafter with reference to FIGS. 1 to 4.

The image forming apparatus according to the present invention is designed to print a toner image onto a printing medium to form a desired image in an electrophotographic manner, and includes a main body 10, a light scanning unit 300, a toner cartridge 100, a waste toner cartridge 200 and a fuser assembly 16.

The light scanning unit 300 serves to scan light L corresponding to data which it is desired to print onto a photosensitive body 210 to form an electrostatic latent image on the outer circumferential surface of the photosensitive body 210. This light scanning unit 300 includes a light source (not shown) form emitting light L such as a laser beam or the like, and a beam deflector 320 for scanning the light L onto the outer circumferential surface of the photosensitive body 210.

The toner cartridge 100 is detachably mounted to a predetermined position of the main body 10 of the image forming apparatus. When toner 139 for printing stored in the toner cartridge 100 is used up, a user opens a door 19 and pulls a handle 143 to replace the spent toner cartridge with a new toner cartridge 100. The toner cartridge 100 preferably includes a hopper 140, a stirring means 400, an auxiliary stirring means 132, a supply roller 134, a developing roller 136 and a toner layer regulating member 137.

The hopper 140 stores toner for printing in a powdered solid state, and is assembled by coupling an upper half casing 141 and a lower half casing 142 to each other as one embodiment.

FIG. 4 is a perspective view showing the detailed internal structure of the toner cartridge 100 from which the upper half casing 141 removed.

Referring to FIG. 4, the stirring means 400 includes a first paddle 410, a second paddle 420, and an elastic member 430 for elastically interconnecting the first paddle 410 and the second paddle 420. The stirring means 400 serves to stir toner stored in the hopper 140 so as to prevent the toner from being coagulated in the hopper, and simultaneously convey the stirred toner to a supply roller 134. A toner residual amount of the hopper 140 acts as a load to the second paddle 420. This load changes the relative position of the first paddle 410 and the second paddle 420, which results in a change in the phase of the rotation angle of an encoder 510. The detection means 500 measures a toner residual amount based on a change in the output signal of a sensor 590 corresponding to a change in the phase of the rotation angle of the encoder 510. That is, the detection means 500 detects a time delay to measure the residual amount of toner using the fact that the rotation angle of the second paddle 420 causes the time delay by deformation of the elastic member 430 which increases depending on the toner residual amount.

To this end, the detection means 500 includes an encoder 510 having slits formed thereon for transmitting light therethrough, an encoder gear 520 for driving the encoder 510, a sensor 590 mounted to the main body 10 of the image forming apparatus for detecting the rotation angle of the encoder 510 by means of the light transmitting through the slits, an encoder spring 515 for allowing the encoder 510 to return to its initial position, and a light shielding plate 530 for blocking the slits when the encoder 510 returns to its initial position so as to shield the transmission of light through the slits.

The auxiliary stirring means 132 is disposed between the stirring means 400 and the supply roller 134. The auxiliary stirring means 132 serves to re-stir a toner for printing 139 being fed from the stirring means 400 immediately before the supply roller 134 to prevent agglomeration of the toner particles and conveyance of an excessive amount of toner to the supply roller 134.

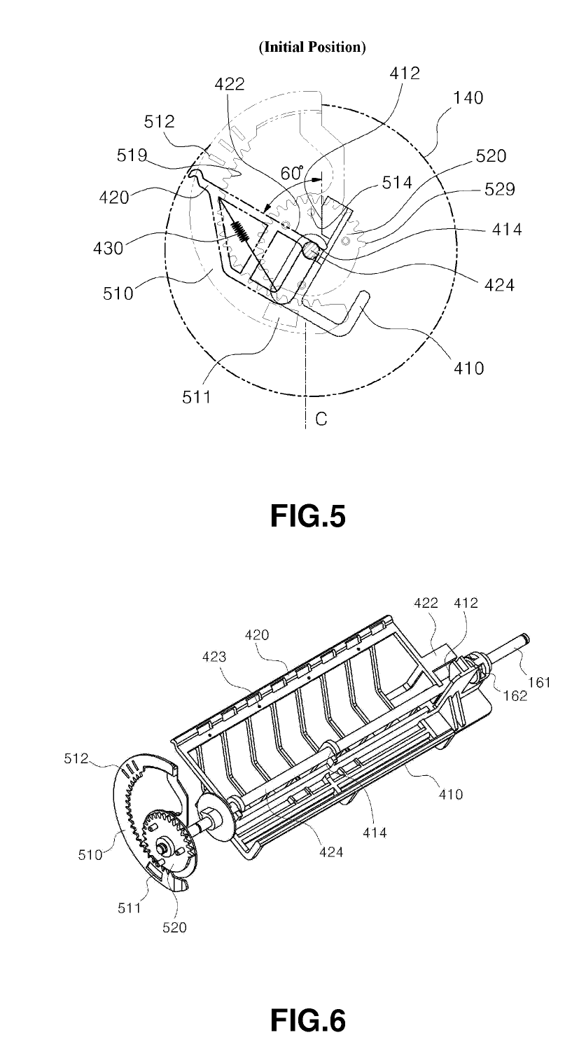

The construction and operation of the stirring means 400, the detection means 500 and the auxiliary stirring means 132 will be described hereinafter with reference to FIGS. 5 to 27.

The supply roller 134 allows the toner 139 for printing to be adhered to the outer circumferential surface of the developing roller 136. The developing roller 136 allows an electrostatic latent image formed in advance on the photosensitive body 210 to be developed as a toner image, and may be applied with a developing bias voltage so as to supply the toner received on the outer circumferential surface of the developing roller 136 to the photosensitive body 210. The toner layer regulating member 137 is elastically biased against the outer circumferential surface of the developing roller 136 by means of an elastic means 138, and regulates the thickness of the toner layer adhered onto the outer circumferential surface of the developing roller 136 into a predetermined thickness.

The waste toner cartridge 200 is detachably mounted at a predetermined position of the main body 10 of the image forming apparatus together with the toner cartridge 100, and stores waste toner separated from the surface of the photosensitive body 210 therein. The waste toner cartridge 200 includes the photosensitive body 210 having the electrostatic latent image formed thereon, a charge roller 230 for uniformly electrically charging the outer circumferential surface of the photosensitive body 210 to a predetermined potential before exposure, and a cleaning element 20 adapted to come into close contact with the outer circumferential surface of the photosensitive body 210 at a given pressure so a to remove toner remaining on the photosensitive body 210 after transfer.

The embodiment of the present invention set forth herein is not limited to the above description. It is noted that various modifications are possible including, for example, an embodiment in which the waste toner cartridge 200 and the toner cartridge 100 are separately provided, an embodiment in which the photosensitive body 210, the charge roller 230 and the like are mounted in the toner cartridge 100, but not in the waste toner cartridge 200, etc.

The photosensitive body 210 is exposed partially at the outer circumferential surface thereof so as to allow light L emitted from the light scanning unit 300 to be scanned onto the photosensitive body 210, and rotates in a predetermined direction. For example, the photosensitive body 210 may be formed by coating a photoconductive material on the outer circumferential surface of a cylindrical drum. The photosensitive body 210 is electrically charged to a predetermined potential on the outer circumferential surface thereof by the charge roller 230, and then is subjected to an exposure process by the light scanning unit 300 to thereby form an electrostatic latent image corresponding to an image which it is desired to print on the outer circumferential surface.

The transfer roller 15 is positioned opposite to the outer circumferential surface of the photosensitive body 210, and may be applied with a transfer bias voltage having an opposite polarity to that of a toner image developed on the photosensitive body 210 using the toner so that the toner image can be fixedly transferred onto a printing medium such a sheet of transfer paper. The toner image is transferred onto the printing medium by means of an electrostatic force or a mechanical contact pressure acting between the photosensitive body 210 and the transfer roller 15.

The fuser assembly 16 includes a pressure roller 16a and a heating roller 16b in tight contact with the pressure roller 16a, and serves to apply heat and pressure to the toner image transferred onto the printing medium to fix the toner image onto the printing medium. A discharge roller 17 discharges the printing medium which has passed through the fuser assembly 16 to a paper deck 18. A printing medium P is withdrawn from a paper supply cassette 11 to a pick-up roller 13 and then is conveyed to the transfer roller 15.

FIG. 5 is a side cross-sectional view illustrating the stirring means 400 and the detection means 500 in the case where there is no toner residual amount in a toner cartridge 100 and the first paddle 410 is in an initial position according to the present invention. The side cross-section view of FIG. 5 is taken long the line B-B′ of FIG. 3. FIG. 6 is a perspective view illustrating the stirring means 400 and the detection means 500 of FIG. 5.

The construction and operation of the stirring means 400 and the detection means 500 will be described hereinafter in more detail with reference to FIGS. 4 to 6.

The first paddle 410 and the second paddle 420 are connected to each other by means of the elastic member 430, which exerts an elastic force on the first paddle 410 and the second paddle 420 in a direction where a first contact portion 412 and a second contact portion 422 are spaced apart from each other. In order to fix the elastic member 430, an elastic member fixing portion 413 and 423 are formed on the first paddle 410 and the second paddle 420, respectively. As the elastic member 430, there is shown a tension spring mounted at one side with respect to the rotation center of the first paddle 410 and the second paddle 420. Besides the tension spring shown as the elastic member 430, a torsion spring mounted at the rotation center of at least one of the first and second paddles may be used as the elastic member and the elastic member fixing portion 413 and 423 may be modified.

In the case where there is no toner residual amount in the hopper 140, since a toner contact torque does not act on the second paddle 420, the first paddle 410 and the second paddle 420 rotates while maintaining an initial relative position of the first paddle 410 and the second paddle 420 interconnected by means of the elastic member 430 as it is. That is, upon the rotation of the first paddle 410 and the second paddle 420, the spacing angle between the first contact portion 412 and the second contact portion 422 and the relative position of the first contact portion 412 and the second contact portion 422 varying depending on the spacing angle are constant.

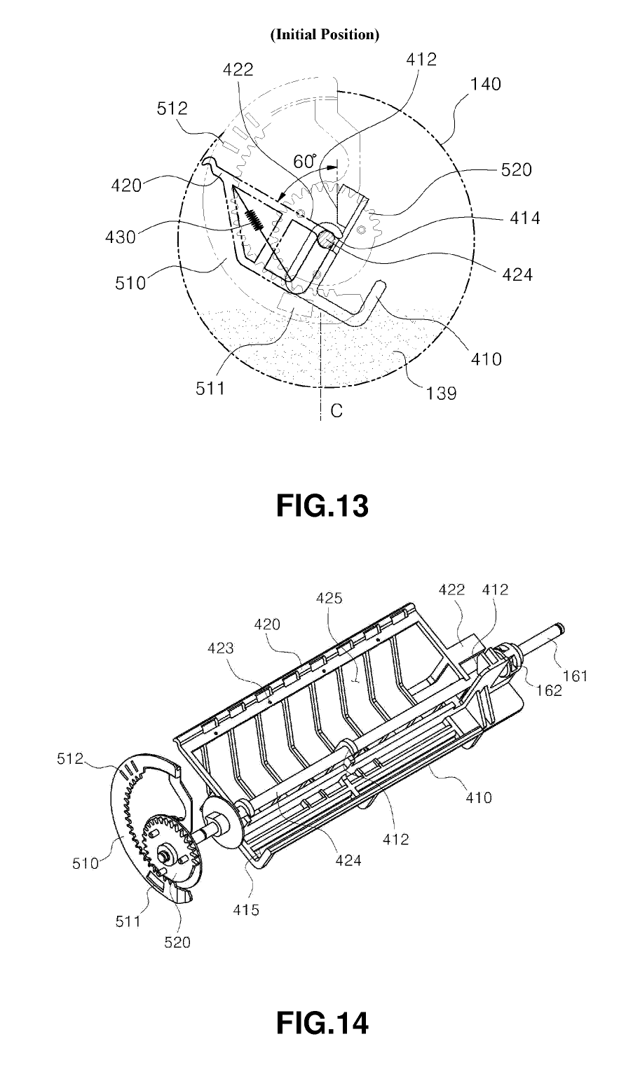

On the other hand, in FIGS. 13 to 25b showing the case where there is a toner residual amount in the hoper 140, the spacing angle between the first contact portion 412 and the second contact portion 422 and the relative position of the first contact portion 412 and the second contact portion 422 vary.

The drive gear 160 (see FIG. 4) is connected to a driving source (not shown) provided at the main body 10 of the image forming apparatus to receive a driving force from the driving source, and rotates at constant speed. A rotation shaft 161 of the drive gear is directly connected to the drive gear 160 so that it rotates together with the drive gear. Since the first paddle 410 is fixed to the rotation shaft 161 of the drive gear (see FIGS. 10 and 16), it has the same rotation center, rotation speed and rotation angle as those of the drive gear 160.

The rotation shaft 424 of the second paddle is connected to the rotation shaft 161 of the drive gear by means of a coupling element 162, but its rotation is not restricted by the rotation shaft 161 of the drive gear. The coupling element 162 merely supports the rotation shaft 161 of the drive gear and the rotation shaft 424 of the second paddle so that the rotation shaft 161 of the drive gear and the rotation shaft 424 of the second paddle are arranged concentrically, but does not transmit a rotational force to the rotation shaft 424 of the second paddle. A hook 414 is integrally formed with the first paddle 410, and receives the rotation shaft 424 of the second paddle so as to enable free rotation of the first paddle. Also, the hook 414 allows a load of the first paddle 410 to be supported by the rotation shaft 424 of the second paddle. Thus, the rotation shaft 424 of the second paddle freely rotates with respect to the rotation shaft 161 of the drive gear.

Since the encoder gear 520 is fixed to the rotation shaft 424 of the second paddle together with the second paddle 420, it has the same rotation center, rotation speed and rotation angle as those of the second paddle 420. Only when an intermittent gear (see reference numeral 529 in FIG. 5) formed on the encoder gear 520 and an intermittent gear (see reference numeral 519 FIG. 5) of the encoder 510 mesh with each other, the encoder 510 rotates.

In other words, the encoder 510 is driven intermittently by the encoder gear 520 and rotates intermittently. When the mesh engagement between the intermittent gears is released, the encoder 511 returns to its initial position by the restoring force of the encoder spring 515.

In one embodiment, when the encoder gear 520 rotates, the encoder 510 starts to rotate in a counter-clockwise direction (when viewed from the positive y-axis in FIG. 4) while the respective intermittent gears mesh with each other, so that the first slit 511 formed at one end side of the encoder first confronts the sensor 590. Then, the encoder gear 520 continues to rotate in a counter-clockwise direction. When the second slit 512 formed at the other end side of the encoder 510 passes by the sensor 590, the mesh engagement between the intermittent gears is released and the encoder 510 rotate in a clockwise direction (when viewed from the positive y-axis in FIG. 4) to thereby return its initial position. In FIG. 4, a torsion spring is shown as one embodiment of the encoder spring 515 so as to elastically bias the encoder 510 in a clockwise direction, but other embodiments are of course possible.

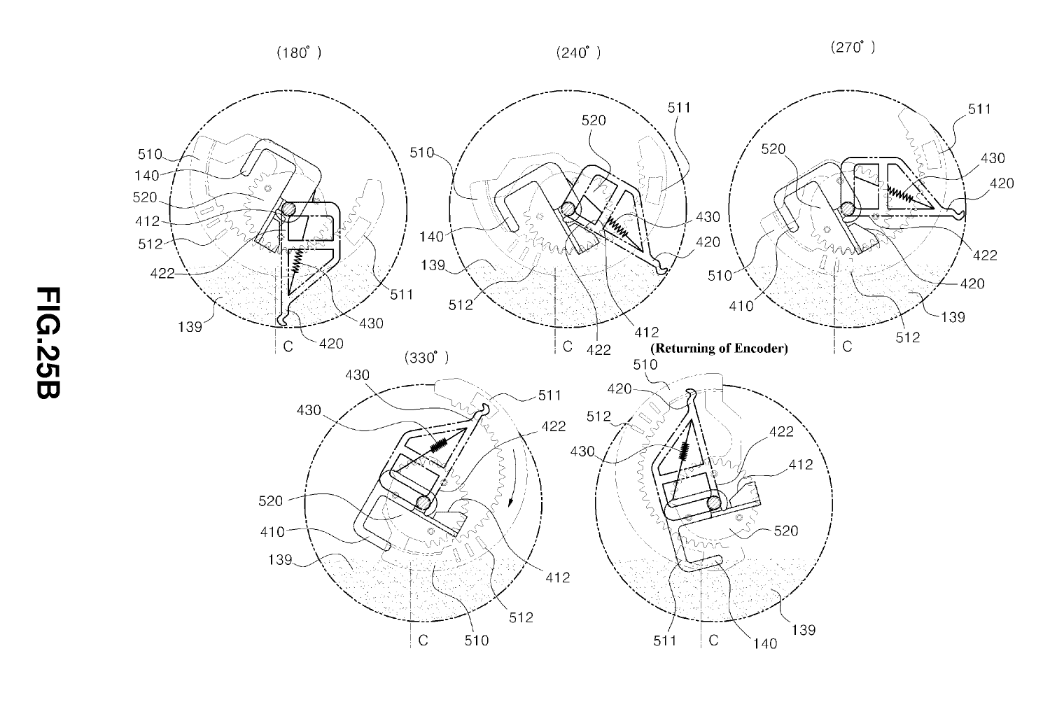

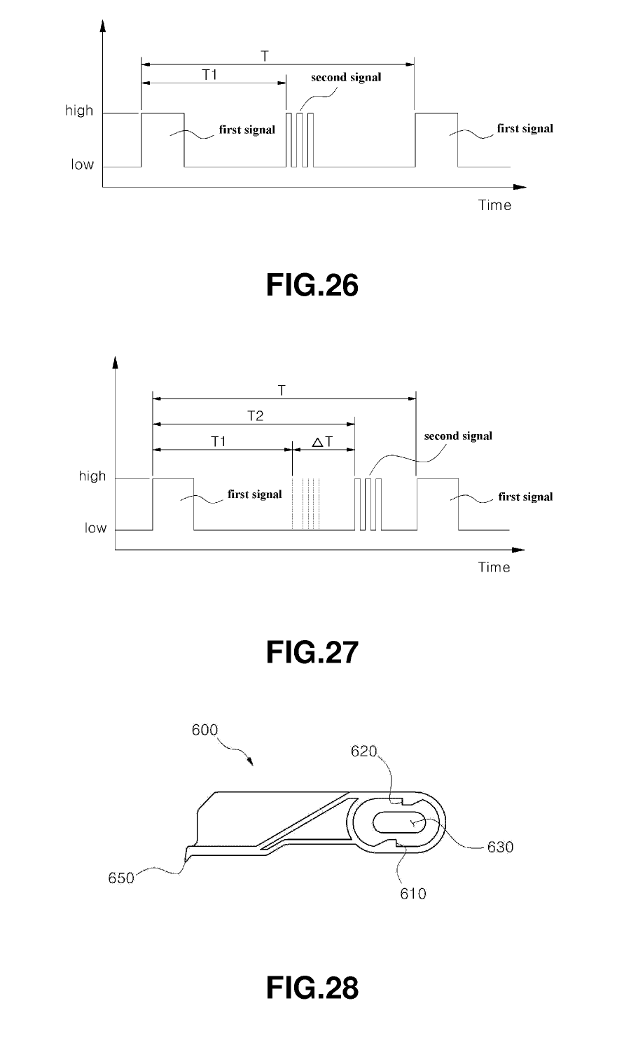

A sensor reference position C indicates the mounting position of the sensor 590 provided in the main body 10 of the image forming apparatus. The encoder 510 includes the first slit 511 for detecting whether or not the encoder passes by the initial position of the encoder, and the second slit 512 mounted spaced apart from the first slit 511 at a predetermined angle so as to generate a signal which is time-delayed depending on a toner residual amount. When the first slit 511 and the second slit 512 pass by the sensor reference position C upon the rotation of the encoder 510, light transmits therethrough to cause the sensor 590 to output a high level signal (see FIG. 26). The number of the second slits 512 is not limited and three second slits 512 shown in the drawing is merely one embodiment.

The first slit 511 and the second slit 512 have widths different from each other. Since such a difference in width is outputted as a difference in the duty cycle of the sensor 590, the sensor 590 can distinguishes between the signal outputs by the first slit 511 and the second slit 512 (see FIG. 26). The initial position written in a parenthesis of FIG. 5 means an initial position of the first paddle 410 immediately before the intermittent gears of the encoder gear 520 and the encoder 510 mesh with each other. In this case, the rotation angle of first paddle 410 is 0°. An original point of an abscissa time axis in FIG. 26 is the time point before the first slit 511 enters the sensor reference position C. At this time, an output of the sensor 590 has a low level.

In the meantime, the light shielding plate 530 is fixed to the rotation shaft 424 of the second paddle along with the encoder gear 520. The light shielding plate 530 blocks the first and second slits 511 and 512 over a section where the encoder 510 elastically returns to its initial position so as to allow the output of the sensor 590 to maintain a low level.

In this case, during the one-time rotation of the first paddle 410, the period of an output of the sensor 590 is T, which is constant and is the same as the output period of the first signal. As shown in FIGS. 26 and 27, since the first paddle 410 rotates at constant speed irrespective of whether or not there is a toner residual amount in the hopper, during the one-time rotation of the first paddle 410 the output (called “the first signal”) of the sensor 590 by the first slit 511 has a constant period T.

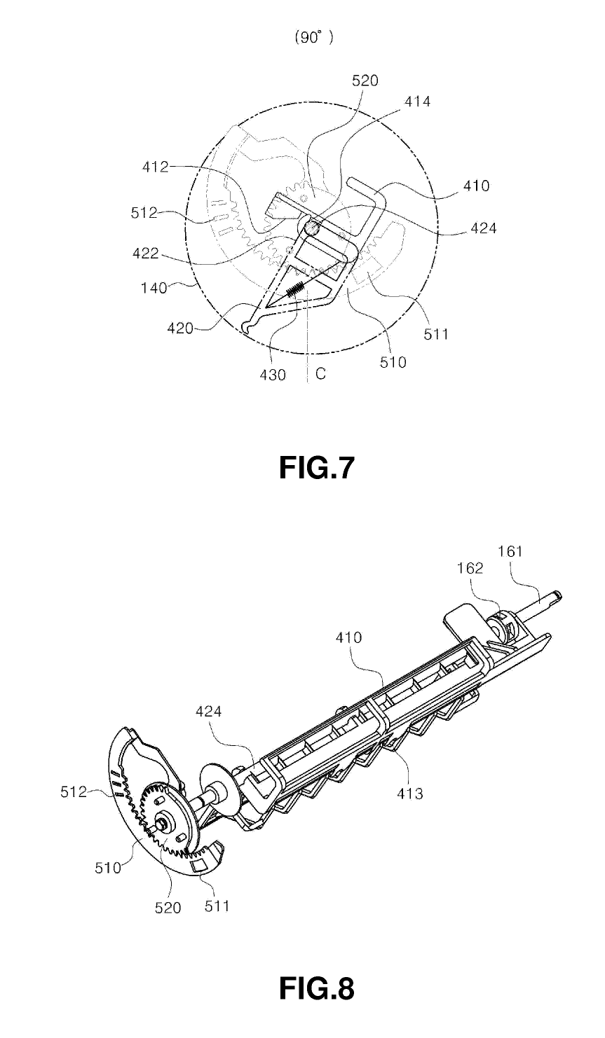

FIG. 7 is a side cross-sectional view illustrating a stirring means 400 and a detection means 500 in the case where there is no toner residual amount in a toner cartridge 100 and a first paddle 410 is in a 90 degree-rotated position according to the present invention, and FIG. 8 is a perspective view illustrating the stirring means 400 and the detection means 500 of FIG. 7.

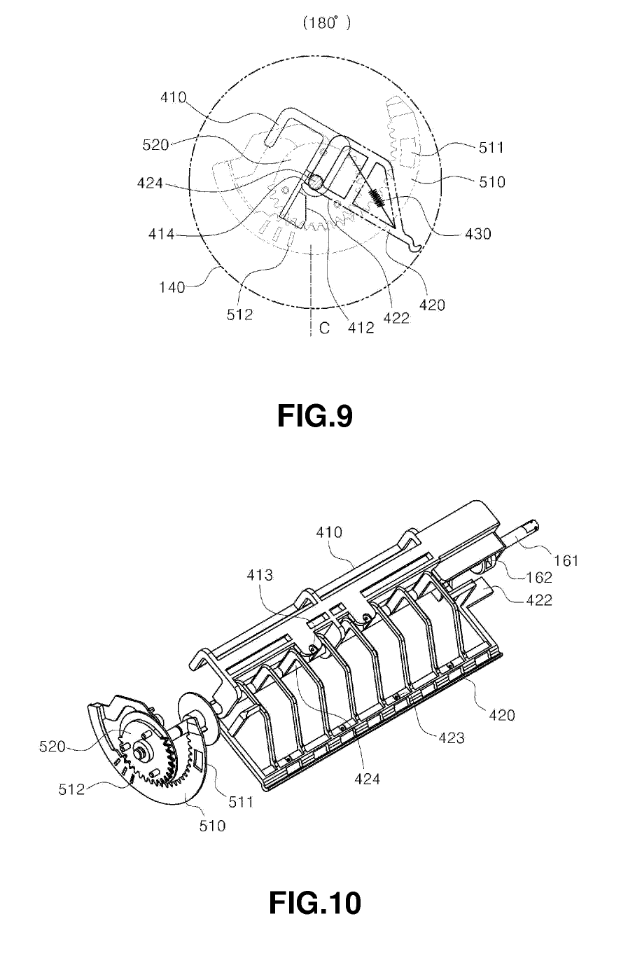

FIG. 9 is a side cross-sectional view illustrating a stirring means 400 and a detection means 500 in the case where there is no toner residual amount in a toner cartridge 100 and a first paddle 410 is in a 180 degree-rotated position according to the present invention, and FIG. 10 is a perspective view illustrating the stirring means 400 and the detection means 500 of FIG. 9.

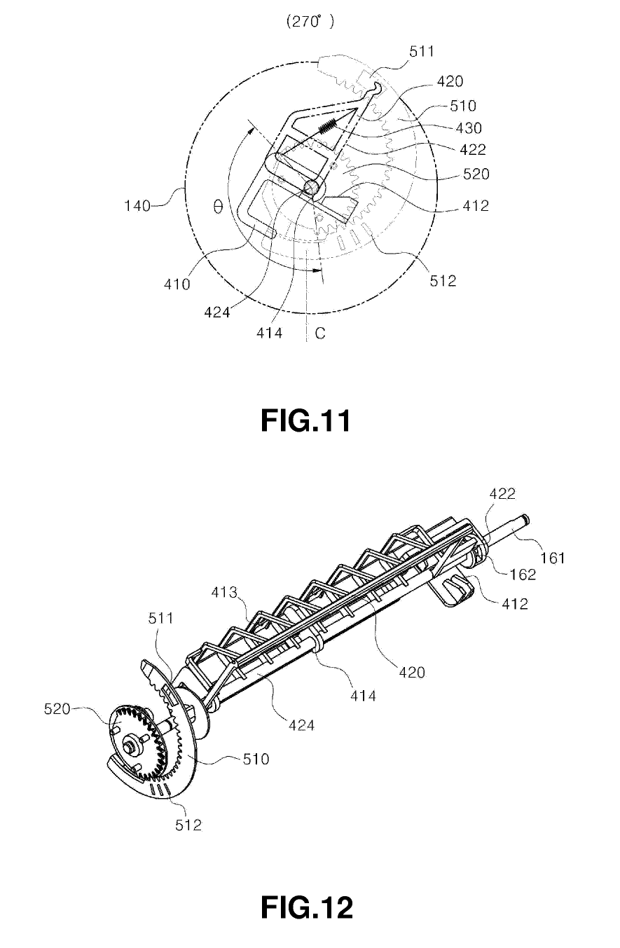

FIG. 11 is a side cross-sectional view illustrating a stirring means 400 and a detection means 500 in the case where there is no toner residual amount in a toner cartridge and a first paddle 410 is in a 270 degree-rotated position according to the present invention, and FIG. 12 is a perspective view illustrating the stirring means 400 and the detection means 500 of FIG. 11.

Referring to FIGS. 4 to 12, in the case where there is no toner residual amount in the hopper 140 of the toner cartridge 100, there is no change in the rotation load of the second paddle 420 when the second paddle is brought into close contact with the toner or the contact between the second paddle and the toner is released. Thus, the relative position of the first paddle 410 and the second paddle 420 is constant irrespective of the rotation angle of the first paddle 410, and the first paddle 410 and the second paddle 420 rotate at constant speed while allowing the spacing angle between the first contact portion 412 and the second contact portion 422 to be maintained equal to that at the initial position of the first paddle 410.

In one embodiment shown in FIGS. 4 to 12, when the rotation angle of the first paddle 410 is within the range between 270° and 330°, the mesh engagement between the intermittent gears formed on the encoder gear 520 and the encoder 510 is released. When the mesh engagement between the intermittent gears is released, the encoder 510 elastically returns to its initial position by means of the restoring force of the encoder spring 515 as shown in FIG. 5.

When the encoder 510 returns to its initial position, as illustrated above, the light shielding plate 530 blocks the transmission of light through the first slit 511 and the second slit 512 so as to allow the output of the sensor 590 to maintain a low level. The light shielding plate 530 includes a protruding extension portion (see reference numeral 532 FIG. 4) having a radius equal to or larger than the distance between the rotation shaft 424 of the second paddle and the sensor 590. The protruding extension portion 532 blocks the first slit 511 and the second slit 512 over a section (reference symbol 0 of FIG. 11) where the intermittent gear 529 (see FIG. 5) of the encoder gear 520 is not formed.

The light shielding plate 530 and the encoder spring 515 are not shown in FIGS. 5 to 25b for the sake of simplicity of illustration, but are shown in FIG. 4. Also, the elastic member 430 elastically interconnecting the first paddle 410 and the second paddle 420 is not shown in some figures corresponding to perspective views of FIGS. 5 to 25b for the sake of simplicity of illustration. The drive gear 160, the rotation shaft 161 of the drive gear and the first paddle 410 have the same rotation center, rotation speed and rotation angle as each other, and the common rotation angle thereof is indicated in a parenthesis in some figures of FIGS. 5 to 25b.

Since the encoder 510 has the rotation center and the radius which are different from those of the encoder gear 520, the encoder 510 and the encoder gear 520 have different rotation angles from each other. The rotation center 514 of the encoder 510 is shown in FIG. 5. The encoder 510 is stationary in a section where the intermittent gears of the encoder and the encoder gear do not mesh with each other. The encoder 510 is different in the rotational direction and the rotation speed from the encoder gear 520 in a section where the encoder 510 returns to its initial position by the encoder spring 515.

The case where there is no toner residual amount in the hopper 140 will be discussed hereinafter.

The drive gear 160 and the first paddle 410 rotate continuously at constant speed by a first angle, and there is no toner contact torque acting on the second paddle 420, and hence the second paddle 420 and the encoder gear 520 also rotate at constant speed at the rotation angle equal to the first angle. However, the encoder 510 is intermittently driven by the encoder gear 520 having a radius different from that of the encoder 510 and returns to its initial position by means of the encoder spring 515, so that it rotates intermittently at a second angle different from the first angle.

Now, the case where there is a certain toner residual amount in the hopper 140 will be described hereinafter with reference to FIGS. 13 to 25b. Most of descriptions of FIGS. 5 to 12 are also applied to those of FIGS. 13 to 25b, and description thereof will be made focused on a difference between the case where there is a certain toner residual amount in the hopper and the case where there is no toner residual amount in the hopper.

The toner residual amount in hopper 140 decreases continuously with an increase of the number of printing paper sheets. In this case, the term “certain toner residual amount” as defined herein refers to the amount of toner remained in the hopper 140 at an arbitrary time point, but the residual amount of toner shown in FIGS. 13 to 25b is taken as an example of the certain toner residual amount for the sake of convenience of explanation.

A front end of the first paddle 410 is defined as a part of the first paddle 410 which is positioned farthest from the rotation shaft 161 of the drive gear serving as the rotation center of the first paddle 410, and a front end of the second paddle 420 is defined as a part of the second paddle 420 which is positioned farthest from the rotation shaft 424 of the second paddle serving as the rotation center of the second paddle 420. The first paddle 410 and the second paddle 420 include apertures 415 and 425 formed therein, respectively, so as to reduce a contact resistance against the toner. The radius of rotation of the front end of the first paddle 410 is much smaller than that of the second paddle 420. Thus, upon the rotation of the first paddle 410 and the second paddle 420 the toner contact torque more greatly acts on the second paddle 420 which is larger in radius of rotation of the front end and size than the first paddle 410. Therefore, for the sake of convenience of explanation, the toner contact torque is defined as a load torque of toner acting on the second paddle 420. In this case, as the toner residual amount increases, a portion of the second paddle 420 which is buried in the toner stored in the hopper increases, thereby resulting in an increase in the toner contact torque.

FIG. 13 is a side cross-sectional view illustrating a stirring means 400 and a detection means 500 in the case where there is a certain toner residual amount in a toner cartridge and a first paddle 410 is in an initial position according to the present invention, FIG. 14 is a perspective view illustrating the stirring means 400 and the detection means 500 of FIG. 13. When the first paddle 410 is in an initial position, since the front end of the second paddle 420 is spaced apart from the surface of the toner, it does not receive the toner contact torque. Also, since there is no deformation of the elastic member 430, the first paddle 410 and the second paddle 420 rotate at the same rotation angle and rotation speed. At this time, since the mesh engagement between the intermittent gears of the encoder gear 520 and the encoder 510 has been released, the encoder 510 is stationary. Since the first slit 511 is positioned at the downstream of the sensor reference position C, the output of the sensor 590 has a low level.

Although there has not been shown the case where the first paddle 410 further rotates from the initial position, the encoder 510 starts to rotate while the intermittent gears of the encoder gear 520 and the encoder 510 is brought into mesh engagement with each other, and the first slit 511 enters the sensor reference position C to cause the output of the sensor to become a high level.

When the first slit 511 passes by the sensor reference position C, the output of the sensor 590 becomes a low level again. In this case, the elastic member 430 is not deformed, and the first paddle 410, the second paddle 420, the encoder gear 520 and the encoder 510 rotate together. As mentioned above, since the encoder 510 and the encoder gear 520 are different in the rotation center and the radius from each other, the rotation angle of the encoder 510 is different from that of the first paddle 410 and the encoder gear 520. In the case where there is a certain toner residual amount in the hopper, the output of the sensor 590 is shown in FIG. 27.

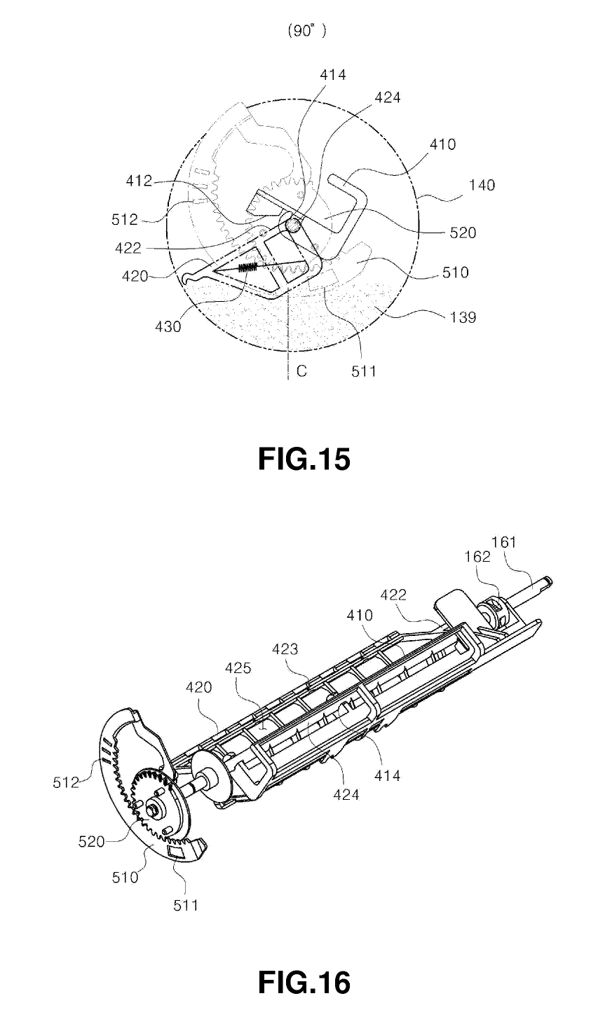

FIG. 15 is a side cross-sectional view illustrating a stirring means 400 and a detection means 500 in the case where there is a certain toner residual amount in a toner cartridge and a first paddle 410 is in a 90 degree-rotated position according to the present invention, FIG. 16 is a perspective view illustrating the stirring means 400 and the detection means 500 of FIG. 15. In this case, the front end of the second paddle 420 is in close contact with the toner, and the second paddle 420, the encoder gear 520 and the encoder 510 are all stationary. At this time, only the first paddle 410 rotate at constant speed and the elastic member 430 is deformed.

Although deformation of the elastic member 430 increases along with rotation of the first paddle 410, if the second paddle 420 and the encoder 510 are stationary but not rotates, the second slit 512 is also stationary and a time delay occurs in the output (called “second signal”) of the sensor 590 corresponding to the second slit 512.

Referring to FIG. 26, in the case where there is no toner residual amount in the hopper, the second signal starts after the time T1 has lapsed since the output (i.e., first signal) of the sensor 590 corresponding to the first slit 511 had started. But referring to FIG. 27, in the case where there is a certain toner residual amount in the hopper, the second signal starts after the time T2 has lapsed since the first signal had started.

A time delay corresponding to a difference between T1 and T2 is indicated as ΔT in FIG. 27.

Referring to FIGS. 26 and 27, in the case where there is no toner residual amount in the hopper, the time delay of the second signal with respect to the first signal is T1, whereas in the case where there is a certain toner residual amount in the hopper, the time delay of the second signal with respect to the first signal is T1+ΔT or T2 which is equal to T1+ΔT.

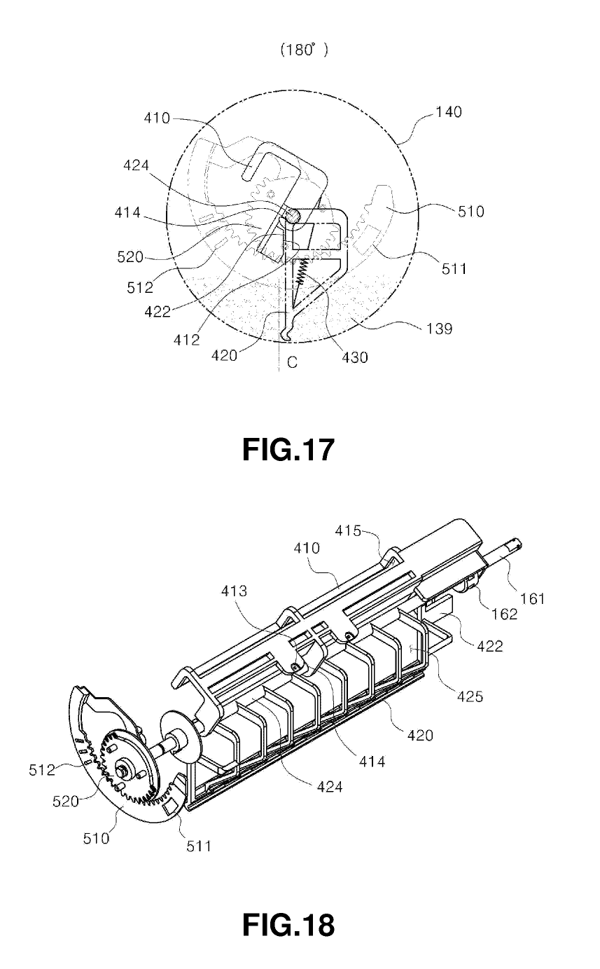

FIG. 17 is a side cross-sectional view illustrating a stirring means 400 and a detection means 500 in the case where there is a certain toner residual amount in a toner cartridge and a first paddle 410 is in a 180 degree-rotated position according to the present invention, and FIG. 18 is a perspective view illustrating the stirring means 400 and the detection means 500 of FIG. 17.

Referring to FIGS. 17 and 18, the first paddle 410 rotates at constant speed by the drive gear 160, and the second paddle 420 is pushed by the first contact portion 412 so that it is moved into the toner to stir the toner stored in the hopper.

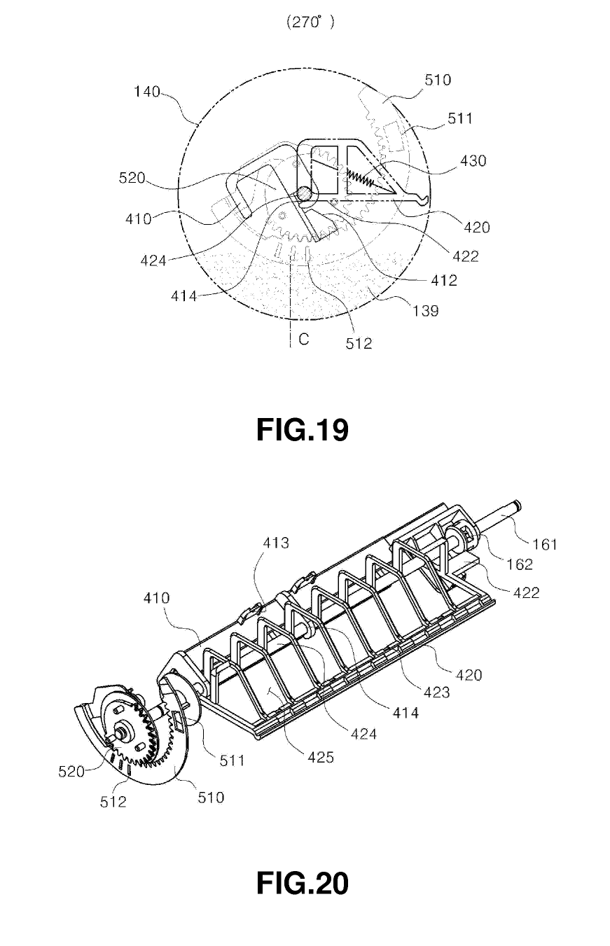

FIG. 19 is a side cross-sectional view illustrating a stirring means 400 and a detection means 500 in the case where there is a certain toner residual amount in a toner cartridge and a first paddle 410 is in a 270 degree-rotated position according to the present invention, and FIG. 20 is a perspective view illustrating the stirring means 400 and the detection means 500 of FIG. 19.

Referring to FIGS. 20 and 18, the first paddle 410 rotates at constant speed, and the second paddle 420 elastically returns toward the first paddle 410. When the elastic returning of the second paddle 420 has been completed, the first paddle 410 and the second paddle 420 will rotate at the same rotation speed and rotation angle as each other.

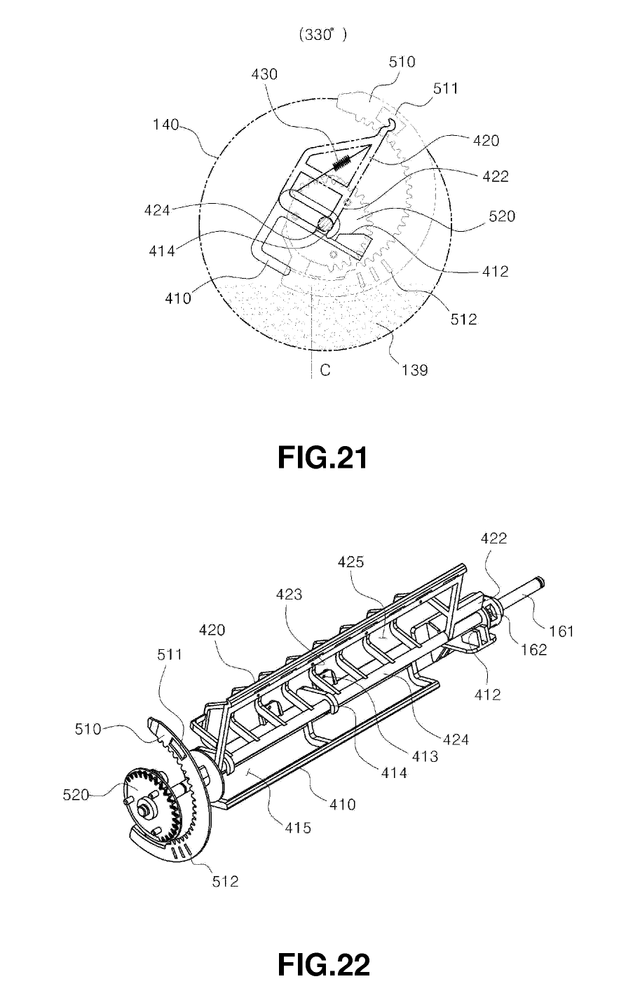

FIG. 21 is a side cross-sectional view illustrating a stirring means 400 and a detection means 500 in the case where there is a certain toner residual amount in a toner cartridge and a first paddle 410 is in a 330 degree-rotated position according to the present invention, and FIG. 22 is a perspective view illustrating the stirring means 400 and the detection means 500 of FIG. 21.

In FIGS. 21 and 22, there is shown a state where the mesh engagement of the intermittent gears formed on the encoder gear 520 and the encoder 510 is released.

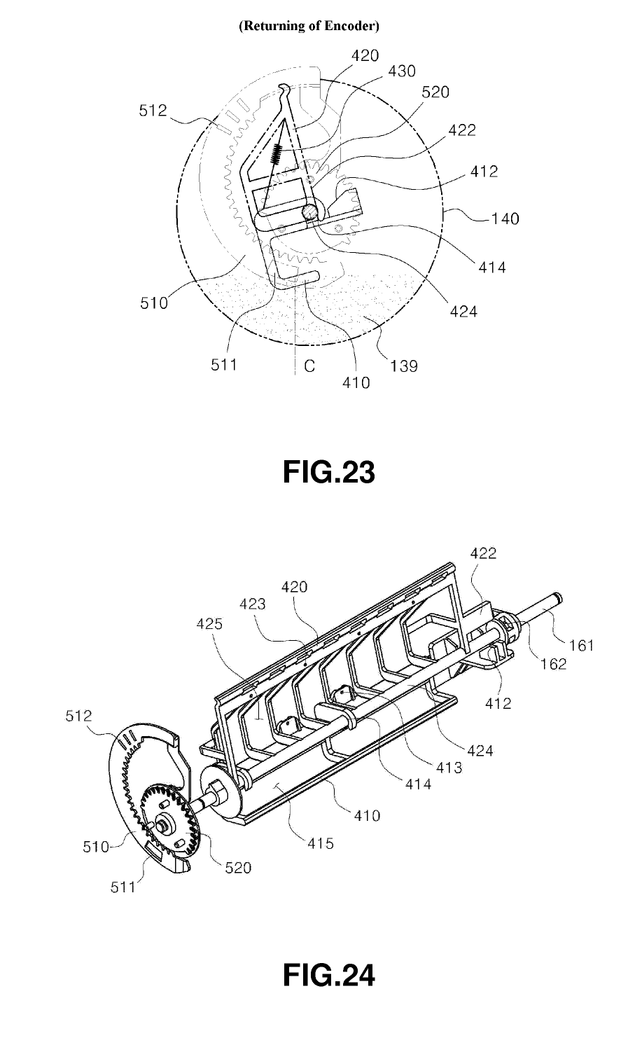

FIGS. 23 and 24 are views illustrating a state where the encoder 510 returns to its initial position.

Referring to FIGS. 23 and 24, when the mesh engagement of the intermittent gears of the encoder gear 520 and the encoder 510 is released, the encoder 510 rotates in a clockwise direction by means of the restoring force of the encoder spring 515 so that it returns to its initial position as shown in FIGS. 13 and 23. As described above, upon the returning of the encoder 510, the protruding extension portion of the light shielding plate 530 blocks the first slit 511 and the second slit 512, and the output of the sensor 590 maintains a low level during the time interval after the second signal (see FIG. 27). Then, when the first paddle 410 further rotates in a counter-clock direction to reach its initial position, the above operation will be repeatedly performed.

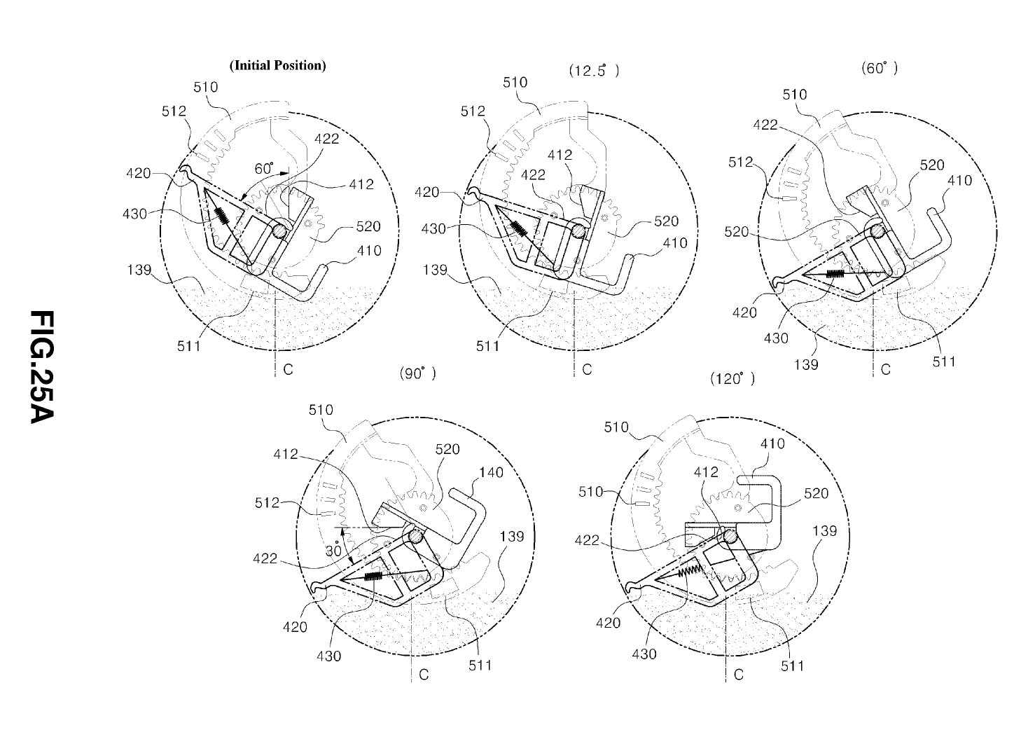

FIGS. 25a and 25b are explanatory views sequentially illustrating the positions of a stirring means and a detection means according to a rotation angle of a first paddle in the case where there is a certain toner residual amount in a toner cartridge.

Referring to FIGS. 25a and 25b, the operation of the stirring means and the detection means can be grasped intuitively.

The rotation angle of the first paddle is indicated in parentheses in FIGS. 25a and 25b. FIGS. 25a and 25b include FIGS. 13, 15, 17, 19, 21 and 23 as they are. Thus, although there is a construction which is not denoted by a reference numeral in constituent elements of FIGS. 25a and 25b, such a construction is considered to be the same as construction which is denoted by a reference numeral of FIGS. 13, 15, 17, 19, 21 and 23. FIGS. 25a and 25b further include figures showing the case where the rotation angles of the first paddle are 12.5°, 60°, 120° and 240°. But there is only a difference in the relative position of respective elements and FIGS. 25a and 25b include the same construction as that shown in FIGS. 13, 15, 17, 19, 21 and 23.

In FIGS. 25a and 25b, when the first paddle 410 is in an initial position, there is no deformation of the elastic member 430 and the spacing angle between the first contact portion 412 and the second contact portion 422 is 60° as one example. In this case, since the toner contact torque does not act on the front end of the second paddle 420, the first paddle 410 and the second paddle 420 rotate at the same rotation angle and rotation speed as each other. When the first paddle 410 rotates by 12.5°, the mesh engagement between the intermittent gears formed on the encoder gear 520 and the encoder 510 is initiated, and thus the rotation of the encoder 510 is initiated. Then, the first slit 511 enters the sensor reference position C to cause the output of the sensor 590 to become a high level. When the first slit 511 completely passes by the sensor reference position C, the output of the sensor 590 becomes a low level.

When the first paddle 410 rotates by 60°, the front end of the second paddle 420 comes into close contact with the toner, so that the toner contact torque starts to act on the front end of the second paddle 420. In this case, the second paddle 420 and the encoder 510 are stopped from rotating, a deformation of the elastic member 430 is initiated, and only the first paddle 410 rotates at constant speed. The first contact portion 412 approaches the second contact portion 422 and the spacing angle therebetween is less than 60°.

When the first paddle 410 rotates by 90°, the second paddle 420 is still stationary by the toner contact torque and the deformation of the elastic member 430 continues to increase. At this time, the encoder 510 is stationary. The first contact portion 412 further approaches the second contact portion 422 and the spacing angle therebetween is 30°.

When the rotation angle of the first paddle 410 is less than 120°, the second paddle 420 and the encoder 510 are stationary.

At the moment when the rotation angle of the first paddle 410 reaches 120°, the contact between the first contact portion 412 and the second contact portion 422 is initiated and the rotation of the second paddle 420 and the encoder 510 is initiated. In this case, since the elastic member 430 is in the maximum deformation state, the maximum restoring force acts on the second paddle 420. Herein, the maximum restoring force is defined as a restoring force acting on the second paddle so as to allow the first contact portion and the second contact portion to be brought into close contact with each other when the elastic member is maximally deformed.

However, the embodiment shown in FIGS. 25a and 25b completely satisfies the following three conditions.

i) The spacing angle between the first contact portion 412 and the second contact portion 422 is selected to be 60° at the initial position of the first paddle,

ii) When the second paddle 420 rotates by 60° from the initial position, the contact between the second paddle and the toner is initiated, and

iii) The toner contact torque is larger than the maximum restoring force.

The above embodiment is merely one embodiment applied to the case where the toner residual amount is above a predetermined value (the toner residual amount shown in FIGS. 25a and 25b)

In this case, the second paddle 420 and the encoder 510 are stopped from rotating over the section where the rotation angle of the first paddle 410 ranges from 60° to 120°, and a time delay ΔT occurs in the second signal. The second signal will be detected at the time point when the time T2 (T1+ΔT) has lapsed after the first signal had been detected (see FIGS. 26 and 27).

Under the above three conditions, the time delay ΔT of the second signal is T/6, which is an upper limit value. That is, the rotation period of the first paddle 410 rotating at constant speed is T. As shown in FIG. 25, when the spacing angle between the first contact portion 412 and the second contact portion 422 is 60° at the initial position, the upper limit value of the time delay ΔT is T/6. The reason for this is because the following proportional expression is established: T:ΔT=360°:60°. In this case, the an upper limit value of the time delay ΔT increase in proportion to the spacing angle between the first contact portion 412 and the second contact portion 422.

However, the toner contact torque decreases with a decrease of the toner residual amount, and thus becomes less than the maximum restoring force. Thus, when the toner residual amount is below a predetermined value, the second paddle 420 starts to rotate even before the contact between the first contact portion 412 and the second contact portion 422 is initiated. The restoring force of the elastic member 430 increases due to a deformation of the elastic member 430 occurring because the second paddle 420 is stationary and the first paddle 410 rotates. The reason for this is because even before the contact between the first contact portion 412 and the second contact portion 422 is initiated, the second paddle 420 is moved into the toner to stir the toner at the moment when the restoring force of the elastic member 430 becomes larger than the toner contact torque.

The time delay ΔT is proportional to the toner residual amount at a linear section where there occurs any deformation of the elastic member 430, i.e., a section where the time delay ΔT is smaller than the upper limit value. When the time delay ΔT is the upper limit value, the second paddle 420 rotates by being pushed by the first contact portion 412 whereas when the time delay ΔT is smaller than the upper limit value, the second paddle 420 rotates by the restoring force of the elastic member 430. When the time delay ΔT is 0, the toner contact torque does not act on the second paddle 420.

In other words, when the toner residual amount is above a predetermined value, the time delay ΔT of the second signal is T/6 and maintains the upper limit value. In this case, a change in the time delay ΔT makes it impossible to detect a change in the toner residual amount. On the other hand, when the toner residual amount is below the predetermined value, the time delay ΔT of the second signal decrease gradually and the output period of the second signal is changed, making it possible to detect a change in the toner residual amount. If there is no toner residual amount in the hopper, the stopping time of the encoder 510 by the toner contact torque is 0. Thus, FIG. 27 becomes equal to FIG. 26.

The stirring means 400 and the detection means 500 of the present invention allows for the detection of the residual amount of toner in the hopper through the above-mentioned operation. Although the second paddle 420 is stopped from rotating upon the contact between the second paddle and the toner, the second paddle 420 also rotates one time during the one-time rotation of the first paddle 410. Thus, the present invention has an advantage in that there is no change in the toner stirring performance and it can measure the toner residual amount through a simple construction of interconnecting the first paddle 410 and the second paddle 420 by means of the elastic member 430.

The detection means 500 detects a change in the time delay ΔT of the second signal to measure the toner residual amount. The time delay ΔT is based on the elastic deformation of the elastic member 430 by the toner contact torque. Thus, when the time delay ΔT is less than the upper limit value, it is linearly changed depending on the toner residual amount. Therefore, the stirring means 400 and the detection means 500 of the present invention can greatly improve linearity of measurement of the toner residual amount.

In addition, as the upper limit value of the time delay ΔT increases, sensitivity and resolution of the sensor 590 can be enhanced. If resolution and sensitivity of the sensor 590 are enhanced, the toner residual amount can be more precisely measured. The spacing angle between the first contact portion and the second contact portion should increase in order to increase the upper limit value of the time delay ΔT. In other words, the sensitivity and resolution of measurement of the toner residual amount can be controlled to a desired level only through a simple structure modification

Referring back to explanation of the embodiment of FIGS. 25a and 25b, when the rotation angle of the first paddle 410 is 180°, the first contact portion 412 pushes the second paddle to cause the second paddle to rotate similarly to the case where the rotation angle of the first paddle 410 is 120°.

When the rotation angle of the first paddle 410 is 240°, the front end of the second paddle 420 starts to escape from the surface of the toner. When the rotation angle of the first paddle 410 is above 240°, the second paddle 420 rotates at higher speed than the first paddle 410 rotating at constant speed by means of the restoring force of the elastic member 430.

Even when the rotation angle of the first paddle 410 is 270°, it is shown that the elastic returning of the second paddle 420 continues.

When the rotation angle of the first paddle 410 is 330°, the second paddle 420 is in a state where rotation of the second paddle by the restoring force of the elastic member 430 is terminated. Since the second slit 512 is in a state of completely passing by the sensor reference position C, detection of the output of the second signal is completed and the mesh engagement between the intermittent gears of the encoder gear 520 and the encoder 510 is released.

When the rotation angle of the first paddle 410 is above 330°, the encoder 510 completely returns to its initial position. Since the light shielding plate 530 rotating coaxially with the encoder gear 520 blocks the first slit 511 and the second slit 512, the output of the sensor 590 shown in FIG. 27 becomes a low level after the second signal starts.

While the present invention has been described with reference to one embodiment shown in the drawings, it will be appreciated that it is merely an illustrative embodiment and various equivalent modifications and variations of the embodiments can be made by a person having an ordinary skill in the art.

For example, the rotation angle of the first paddle at the time point when the first signal and the second signal are outputted, the rotation angle of the first paddle at the time point when the intermittent gears of the encoder and the encoder gear mesh with each other and the mesh engagement between the intermittent gears is released, the number of the second slits, the sensor reference position, the spacing angle between the first contact portion and the second contact portion at the initial position, the relative position of the first paddle and the second paddle at the initial position, matters explained by limiting a numerical value in the set forth description, and the like may be variously modified depending on the embodiments of the stirring means and the detection means and the coupling relationship therebetween.

In the meantime, according to another embodiment of the present invention, as described above in the construction of FIG. 1, the auxiliary stirring roller 132 is disposed between the stirring means 400 and the supply roller 134 and re-stirs a toner for printing 139 being fed from the stirring means 400 immediately before the supply roller 134 to prevent agglomeration of the toner particles and conveyance of an excessive amount of toner to the supply roller 134.

The auxiliary stirring means of the present invention is connected to the stirring means and rotates by receiving the driving force from the driving source.

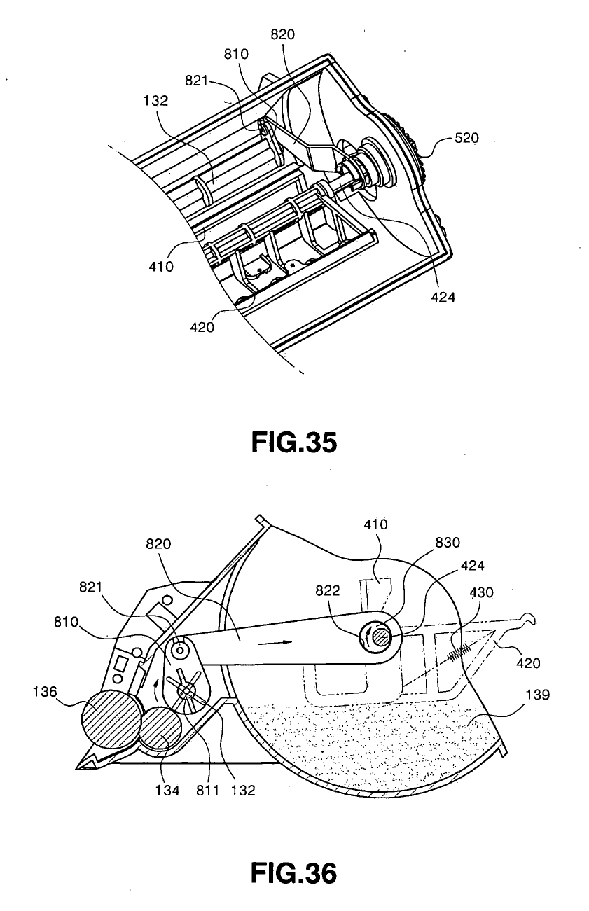

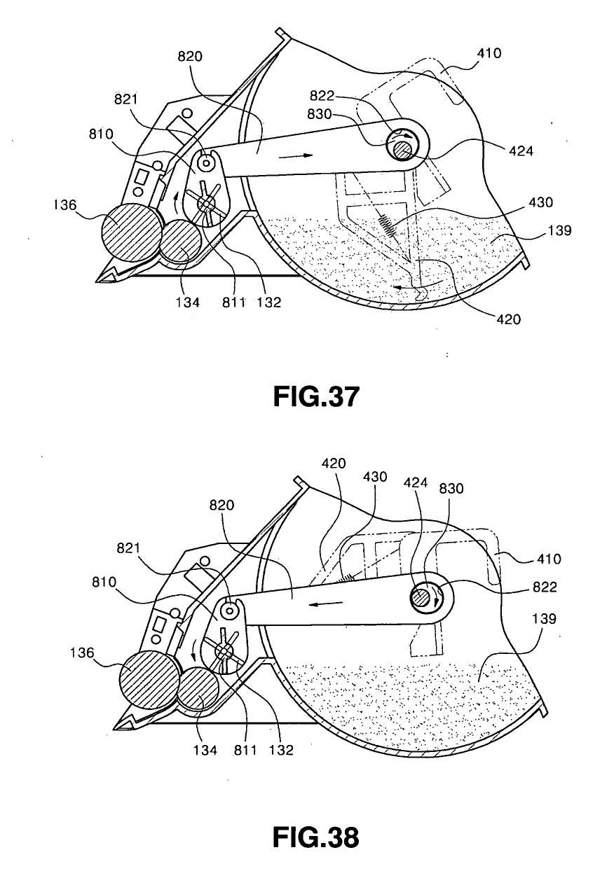

The embodiment of the shown auxiliary stirring means includes four types such as a first embodiment shown in FIGS. 28 to 31, a second embodiment shown in FIGS. 32 to 34, a third embodiment shown in FIGS. 35 to 39, a fourth embodiment shown in FIGS. 40 to 43. However, the embodiment of the shown auxiliary stirring means is not limited thereto, but various modifications can be made to the embodiments.

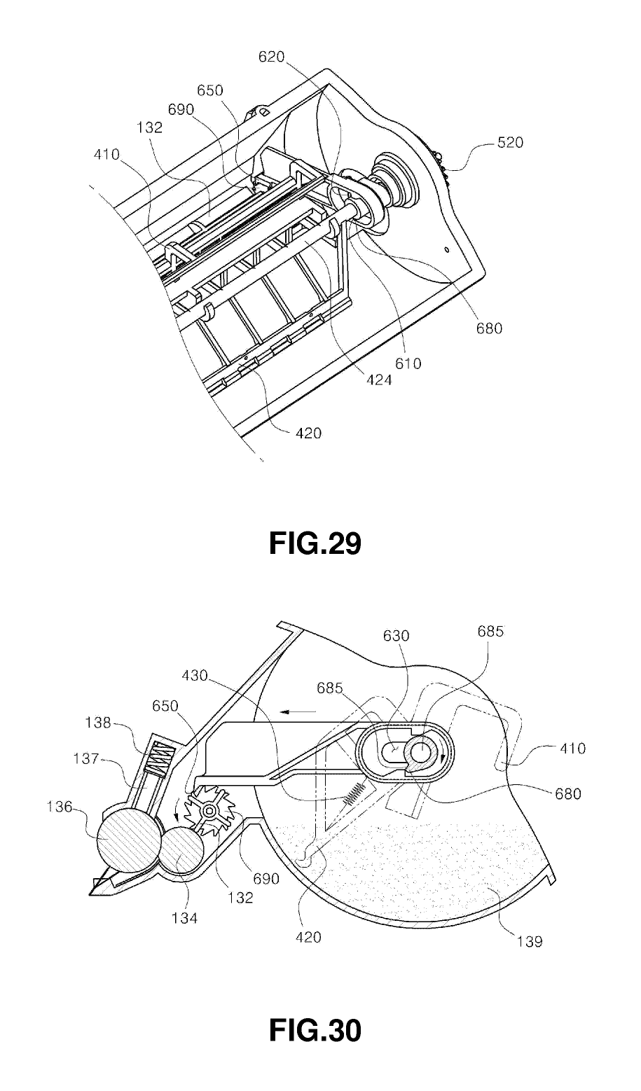

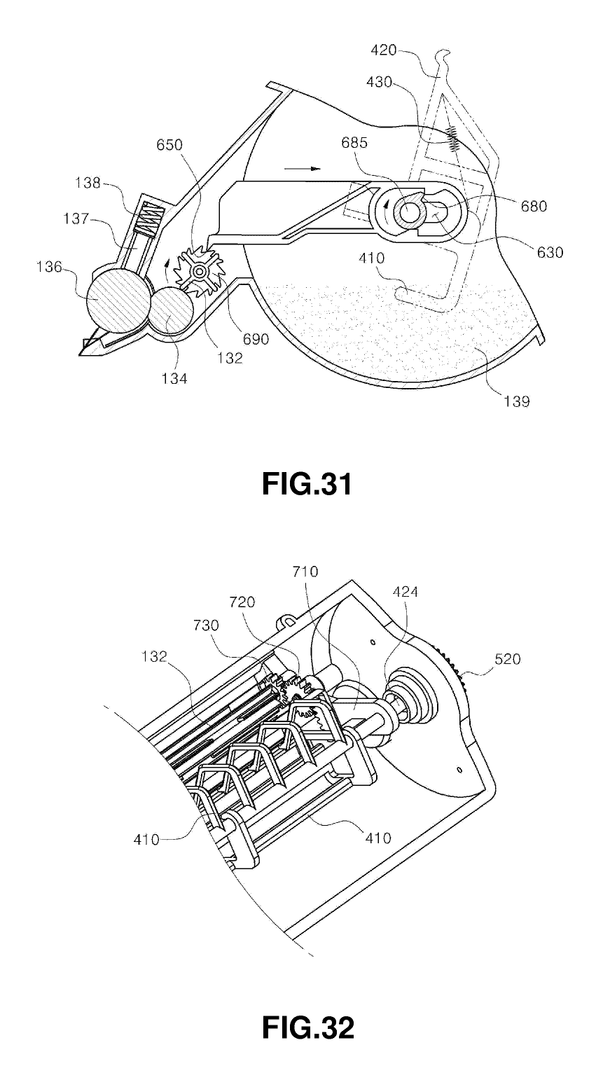

Now, the first embodiment of the auxiliary stirring means will be described hereinafter. FIG. 28 is a front view illustrating a pawl member of the present invention. FIG. 29 is a perspective view illustrating the internal construction of a toner cartridge including an auxiliary stirring means of a first embodiment according to the present invention. FIGS. 30 and 31 are side cross-sectional views illustrating the operation of the auxiliary stirring means of the first embodiment according to the present invention.

The auxiliary stirring means of the first embodiment includes an auxiliary stirring roller 132, a ratchet 690 and a pawl movement member 600. The ratchet 690 is fixed to one side of the auxiliary stirring roller 132 and rotates coaxially with the auxiliary stirring roller. The ratchet 690 rotates by the linear movement of a pawl in engagement with the ratchet. The pawl movement member 600 is connected to the stirring means and is linearly moved to drive the ratchet 690.

All the embodiments of the auxiliary stirring means feature that the auxiliary stirring means receives a driving force transmitted to the stirring means or a power from the same driving source as the driving force so that it is eventually driven in synchronization with the operation of the stirring means without needing an independent separate driving source.

The stirring means of the present invention, as described above, includes the first paddle, the second paddle and the elastic member for elastically interconnecting the first paddle and the second paddle. Among these elements, an element greatly affecting the stirring of the toner is the second paddle 420, and as shown in FIG. 30, when the front end of the second paddle 420 reaches the proximity of the supply roller 134, the toner is concentratedly conveyed to the supply roller 134 side. Thus, it is preferably to synchronize the time point when the auxiliary stirring roller 132 rotates with the time point when the front end of the second paddle 420 reaches the proximity of the supply roller.

Therefore, referring to FIG. 30, when the front end of the second paddle 420 approaches the proximity of the supply roller 134, the pawl movement member 600 is moved in a first direction to cause the pawl to engage with the ratchet 690 to thereby rotate the auxiliary stirring roller 132. As a result, agglomeration of the toner particles being supplied to the supply roller 132 is prevented and conveyance of an excessive amount of toner to the supply roller 134 is suppressed.

In the meantime, referring to FIG. 31, when the front end of the second paddle 420 is moved far away from the supply roller 134, the pawl movement member 600 is moved in a second direction opposite to the first direction to cause the engagement of the pawl 650 and the ratchet 690 to be released. As a result, since a load for driving the auxiliary stirring roller 132 hinders the operation of the stirring means, the performance deterioration can be prevented.

To this end, the pawl movement member 600 preferably includes a protruding cam 680, a first slider 610, a second slider 620, a boss 685 and a slot 630. The protruding cam 680 is preferably driven by being connected to the second paddle 420 of the paddles rotating in the hopper. The first slider 610 is a step intervened by the protruding cam 680 and allows the pawl movement member 600 to be linearly moved in the first direction. The second slider 620 is also a step intervened by the protruding cam 680 and is provided symmetrically with the first slider 610. The second slider 620 allows the pawl movement member 600 to be linearly moved in the second direction so as to release the tooth engagement between the pawl 650 and the ratchet 690. The boss 685 is a rotation shaft of the protruding cam 680 and is preferably a rotation shaft of the second paddle 420. The slot allows the boss 685 to be movably fit thereto and prevents the interference of the linear movement of the pawl movement member 600 upon the linear movement of the pawl movement member 600.

Next, the second embodiment of the auxiliary stirring means will be described hereinafter.

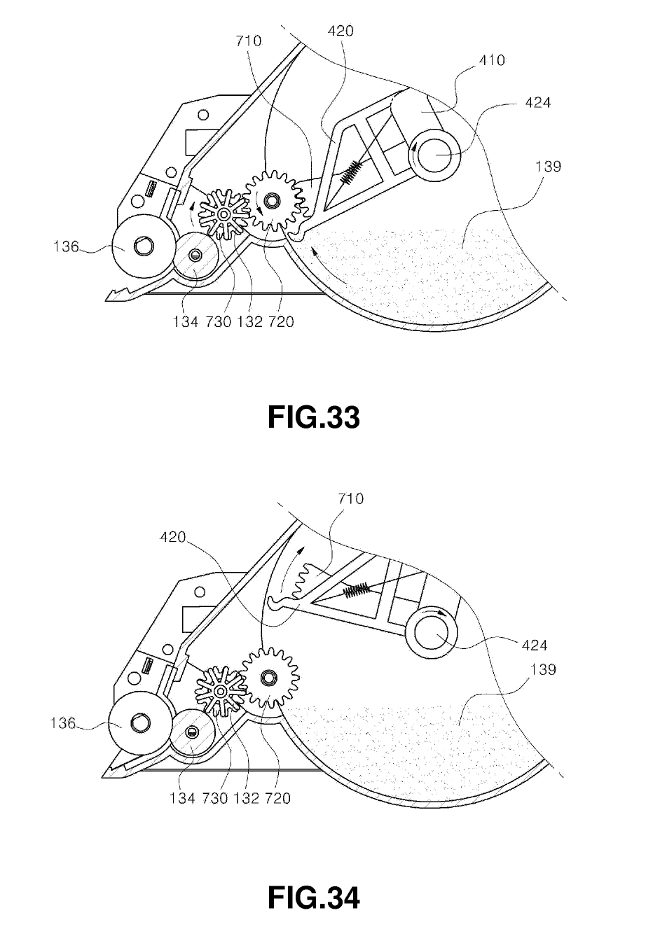

FIG. 32 is a perspective view illustrating the internal construction of a toner cartridge including an auxiliary stirring means of a second embodiment according to the present invention. FIGS. 33 and 34 are side cross-sectional views illustrating the operation of the auxiliary stirring means of the second embodiment according to the present invention.

The auxiliary stirring means of the second embodiment includes an auxiliary stirring roller 132, a roller gear 730, an intermittent gear 710 and a relay gear 720. The roller gear 730 is fixed to one side of the auxiliary stirring roller 132 and transmits a driving force to the auxiliary stirring roller 132. The relay gear 720 is provided between the roller gear 730 and the intermittent gear 710, and is used either in the case where the intermittent gear 710 and the roller 730 is spaced apart from each other to the extent that it is difficult to engage with the intermittent gear 710 and the roller 730, or for the purpose of converting the rotation direction of the roller gear 730. The intermittent gear 710 intermittently drives the roller gear 730. Since the toner is mostly conveyed to the supply roller 134 by means of the second paddle 420, the driving timing of the intermittent gear 710 is preferably synchronized with that of the second paddle 420.

Referring to FIG. 33, when the front end of the second paddle 420 approaches the proximity of the supply roller 134, the tooth engagement between the intermittent gear 710 and the relay gear 720 is initiated. The auxiliary stirring roller 132 starts to rotate by the rotation of the roller gear 730 in tooth-engagement with the relay gear 720. Thus, the toner supplied by the second paddle 420 is stirred again by the auxiliary stirring roller 132.

Referring to FIG. 34, when the front end of the second paddle 420 is moved far away from the supply roller 134 and the toner is no longer supplied to the supply roller 134, the intermittent gear 710 is separated from the relay gear 720. Thus, the auxiliary stirring roller 132 does not rotate and the toner stirring characteristic of the stirring means is not influenced by the driving load of the auxiliary stirring roller 132. The intermittent gear 710, the relay gear 720 and the roller gear 730 are provided in the hopper, and the relay gear 720 may be provided in plural numbers. Although not shown, an alternative embodiment is possible in which the roller gear 730 and the intermittent gear 710 are directly brought into tooth-engagement with each other without the relay gear 720.

For the purpose of synchronization with the second paddle 420, the intermittent gear 710 is preferably fixed to the rotation shaft of the second paddle 420 to rotate together with second paddle 420.

Subsequently, the third embodiment of the auxiliary stirring means will be described hereinafter.

FIG. 35 is a perspective view illustrating the internal construction of a toner cartridge including an auxiliary stirring means of a third embodiment according to the present invention. FIGS. 36 to 39 are side cross-sectional views illustrating the operation of the auxiliary stirring means of the third embodiment according to the present invention.

The auxiliary stirring means of the third embodiment includes an auxiliary stirring roller 132, a first link 810, a second link 820 and an eccentric cam 830. A roller fixing portion 811 to which the rotation shaft of the auxiliary stirring roller 132 is fixed is provided at one side of the first link 810. When the first link 810 rotates about the roller fixing portion, the auxiliary stirring roller 132 rotates. A connecting rod 821 of the second link 820 is assembled to the other side of the first link 810 so that the first link 810 receives a driving force from the stirring means. The connecting rod is provided at one side of second link 820 and an eccentric cam inserting portion 822 for rotatably inserting the eccentric cam 830 thereto is formed at the other side of the second link 820. The eccentric cam 830 is eccentrically fixed to the rotation shaft 424 of the second paddle 420 to which the second paddle 420 is fixed, so that the eccentric cam rotate together with the second paddle 420.

The second link 820 and the first link 810 are operated in cooperation with each other upon the rotation of the eccentric cam 830, and thus the driving force is transmitted from the stirring means to the auxiliary stirring roller 132. FIGS. 36 to 39 show the stepwise operation of the auxiliary stirring means for every 90° increase in the rotation angle of the eccentric cam 830. It can be observed from FIGS. 36 to 39 that each time when the rotation angle of the eccentric cam 830 increases by 90°, the rotation direction of the auxiliary stirring roller 132 is reversed.

Next, the fourth embodiment of the auxiliary stirring means will be described hereinafter.

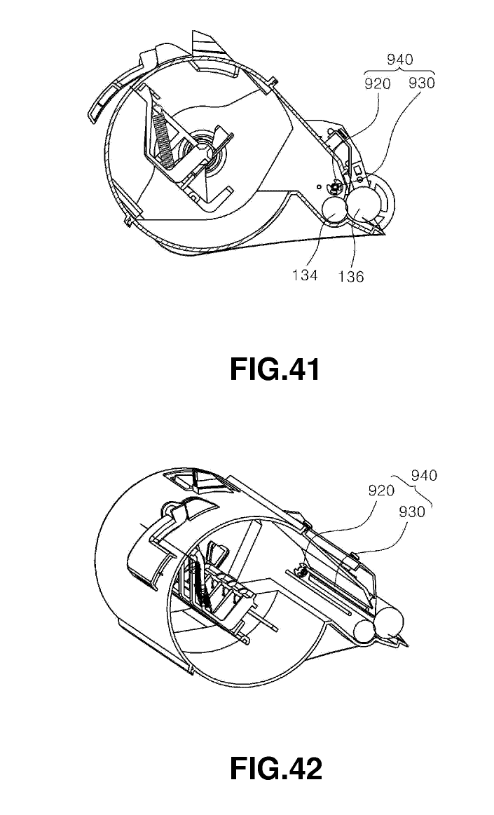

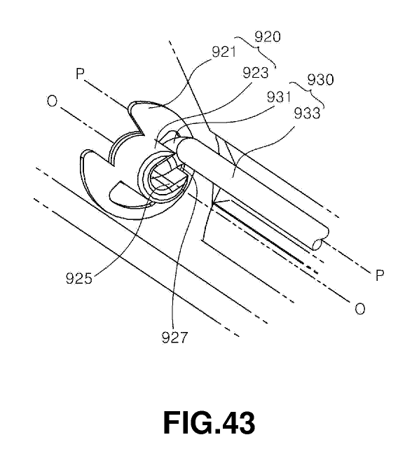

FIG. 40 is an outer side view illustrating the internal construction of a toner cartridge including an auxiliary stirring means of a fourth embodiment according to the present invention, FIG. 41 is a partial side cross-sectional view schematically illustrating the auxiliary stirring means of the fourth embodiment according to the present invention, FIG. 42 is a partially cut perspective view schematically illustrating the auxiliary stirring means of the fourth embodiment according to the present invention, and FIG. 43 is a partially exploded perspective view schematically illustrating the auxiliary stirring means of the fourth embodiment according to the present invention.

The auxiliary stirring means of the fourth embodiment according to the present invention includes an auxiliary stirring wire portion 940 and a wire roller gear 910. The auxiliary stirring wire portion 940 is disposed between the stirring means and the supply roller 134, and intermittently re-stirs the toner being supplied from the stirring means. The wire roller gear 910 rotates the auxiliary stirring wire portion 940, and the driving force for rotating the auxiliary stirring wire portion 940 is transmitted from the drive gear 160 connected to the driving source (not shown) to the wire roller gear 910 through a gear train 950 as a power transmission means. That is, the wire roller gear 910 rotatably mounted to the outer side of the hopper 140 rotates by receiving the driving force transmitted from the drive gear 160 through the gear train 950. Although not shown definitely in the drawings, as for the driving force transmitted through the drive gear 901 a construction may be taken in which the power is transmitted to the drive gear for driving the stirring means 400 through a separate gear train.

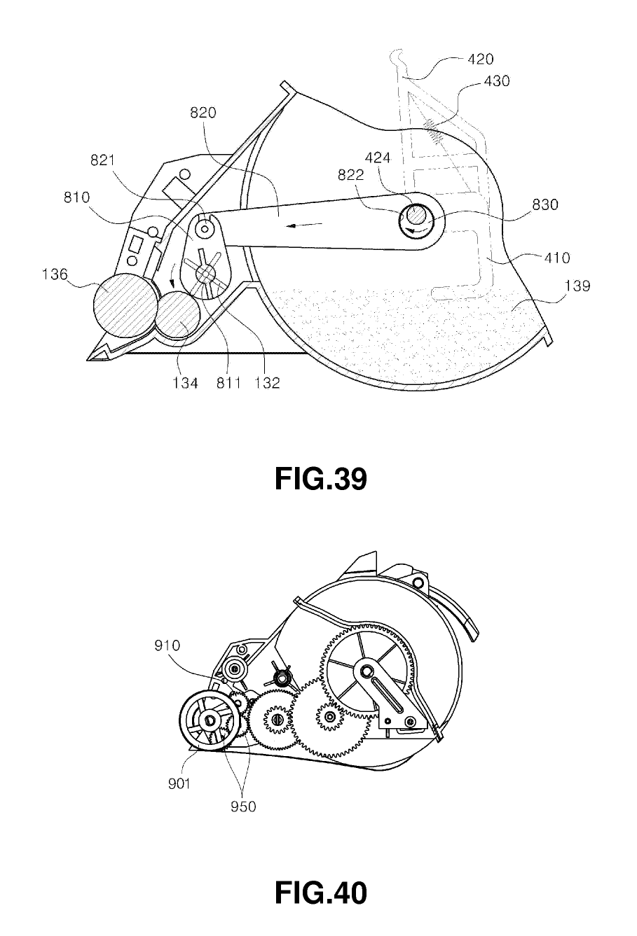

Although it is shown that the gear train 950 according to the present invention takes a construction in which the drive gear 901 is coaxially connected with the developing roller 136 (see FIG. 39), the gear train 950 includes a gear which is directly coaxially connected to an idle gear and the supply roller 134, and the wire roller gear 910 receives the power from the drive gear 901 through the gear train 950, a construction may be taken in which the wire roller gear 910 is directly connected to the drive gear according to the circumstances. In addition, a construction may be taken in which a predetermined revolution ratio is adjusted and/or the gear train 950 further includes a plurality of idle gears for compensating for the distance between the rotation shafts thereof, and a variety of constructions are possible.

The rotation speed of the wire roller gear 910 can be set within a predetermined range through the gear train 950. In addition, the drive gear 901 and the gear train 950 may achieve transmission of the power to the stirring means 400 (see FIG. 1) through another gear train.

In this case, the auxiliary stirring wire portion 940 includes an auxiliary stirring wire stirrer 930. The auxiliary stirring wire stirrer 930 is connected to the wire roller gear 910 and its lengthwise central axis is radially spaced apart from the center of the wire roller gear 910 so as to re-stir the toner. In this embodiment, the auxiliary stirring wire stirrer 930 includes an auxiliary stirring wire body 933 and an auxiliary stirring wire body connector 931. The auxiliary stirring wire body connector 931 is connected to the wire roller gear 910, and the auxiliary stirring wire body 933 is connected to the auxiliary stirring wire body connector 931. In this case, the lengthwise central axis (line P-P) of the auxiliary stirring wire body 933 is spaced apart from the rotation center (line 0-0) of the wire roller gear 910, so that the auxiliary stirring wire body 933 re-stirs the toner. That is, in this embodiment, the auxiliary stirring wire stirrer 930 has a “U” shape and rotates together with the wire roller gear 910 so that it pivotally rotates about the rotation central axis (line 0-0) of the wire roller gear 910 so as to prevent agglomeration of the toner particles and conveyance of an excessive amount of toner to the supply roller 134, thereby eventually maintaining an excellent printing performance.

In the meantime, the auxiliary stirring wire stirrer 930 according to the present invention can prevent a deterioration of the printing performance which may occurs due to an inaccurate stirring operation by the relative rotation between the wire roller gear 910 and the auxiliary stirring wire stirrer 930. That is, as shown in FIG. 43, the auxiliary stirring wire portion 940 further includes an auxiliary stirring wire connector 920. The auxiliary stirring wire connector 920 is disposed on the inner surface of the hopper 140. The auxiliary stirring wire connector 920 penetrates through a side of the hopper 140 and is connected rotatably to the wire roller gear 910. In this case, the auxiliary stirring wire body connector 931 of the auxiliary stirring wire stirrer 930 is connected to the auxiliary stirring wire connector 920 and/or the wire roller gear 910, so that stable rotation of the auxiliary stirring wire stirrer 930 through the wire roller gear 910 can be secured.

The auxiliary stirring wire connector 920 includes an auxiliary stirring wire portion connecting plate 921 and an auxiliary stirring wire portion rotation stopper 923. The auxiliary stirring wire portion rotation stopper 923 extends from one surface of the auxiliary stirring wire portion connecting plate 921. The auxiliary stirring wire portion rotation stopper 923 has a central through-hole 925 formed at the center thereof, and has a lateral through-hole 927 formed at a side thereof. The auxiliary stirring wire portion rotation stopper 923 takes a structure in which the auxiliary stirring wire body connector 931 is penetratingly inserted into the central through-hole 925 and the lateral through-hole 927. That is, an end of the auxiliary stirring wire body connector 931 is connected to the wire roller gear 910 while passing through the central through-hole 925. In this case, a side of the auxiliary stirring wire body connector 931 is at least partially penetrated trough the lateral through-hole 927, and the penetration spacing of the lateral through-hole 927 is set to be equal to or slightly larger than the diameter of the auxiliary stirring wire body connector 931. Therefore, in the case where the connection between the wire roller gear 910 and the auxiliary stirring wire stirrer 930 is loosened or a spacing is generated in the connection through the repeated operation, the lateral through-hole 927 is brought into close contact with the auxiliary stirring wire body connector 931 so that the relative movement between the auxiliary stirring wire stirrer and the wire roller gear is prevented eventually, thereby achieving a stable and accurate auxiliary stirring operation.

In order to obtain a desired performance for the rotational direction, the rotation initiating timing, the rotation angle and the like of the auxiliary stirring roller/auxiliary stirring wire portion in the above embodiments, any one of the four embodiments as described above may be selected arbitrarily.

The present invention can measure the toner residual amount over the consecutive toner levels with sufficient detection resolution and sensitivity, as well as measure the toner residual amount using any deformation of the elastic member in a section where there is a deformation of the elastic member, so that linearity of measurement of the toner residual amount is greatly improved. In addition, the present invention can implement the stirring means and the detection means in a simple structure, can improve cost and reliability of the toner residual amount measurement, and allows the first paddle and the second paddle changed in the relative position therebetween depending on the toner contact torque to be mounted inside the hopper, so that the toner residual amount can be measured while having no influence on the stirring performance of the toner, Further, the present invention has an advantage in that since the encoder is formed in a semicircular strip shape and is different from the encoder gear in terms of rotation center, radius, rotation speed and rotation angle, the structure of the encoder can be simply modified to control the resolution and sensitivity of the detection.

Moreover, the toner cartridge according to the present invention has an advantage in that it can prevent agglomeration of the toner particles between the stirring means and the supply roller or conveyance of an excessive amount of toner to the supply roller, and the stirring means can be intermittently driven through a simple power transmission structure form the driving source for driving the stirring means, so that the stirring characteristic of the stirring means is not substantially influence by the driving load.

Although the present invention has been described in connection with the exemplary embodiments illustrated in the drawings, it is only illustrative. It will be understood by those skilled in the art that various modifications and equivalents can be made to the present invention. Therefore, the true technical scope of the present invention should be defined by the appended claims.

What is claimed is:

1. A toner cartridge comprising:
a hopper for storing toner therein;
a stirring means for stirring the toner in the hopper, the stirring means comprising a first paddle connected to a driving source and adapted to rotate in the hopper, a second paddle adapted to receive a load contact torque larger than a load contact torque acting on the first paddle, and an elastic member for elastically connecting the second paddle to the first paddle; and
a detection means for detecting a time delay to measure the residual amount of the toner based on the fact that deformation of the elastic member according to the toner residual amount causes the time delay in the rotation angle of the second paddle.

2. The toner cartridge according to claim 1, wherein the first paddle is provided with a first contact portion and the second paddle is provided with a second contact portion,
wherein if the toner residual amount is above a predetermined value, the second paddle stirs the toner in the hopper by the contact between the first contact portion and the second contact portion, and
wherein if the toner residual amount is below the predetermined value, the second paddle stirs the toner in the hopper by the restoring force of the elastic member.

3. The toner cartridge according to claim 2, wherein if the toner residual amount is above the predetermined value, the time delay maintains an upper limit value, and wherein if the toner residual amount is below the predetermined value, the time delay decreases as the toner residual amount decreases.

4. The toner cartridge according to claim 2, wherein the following proportional expression is established:
The rotation period of the first paddle: the upper limit value of the time delay=360°: the spacing angle between the first contact portion and the second contact portion.

5. The toner cartridge according to claim 1, wherein the first paddle and the second paddle include apertures formed therein so as to reduce a contact resistance against the toner, and the radius of rotation of the front end of the second paddle is larger than that of the first paddle.

6. The toner cartridge according to claim 1, wherein the rotation center of the first paddle is a rotation shaft of a drive gear connected to the driving source, and the rotation center of the second paddle is a rotation shaft of the second paddle, the rotation shaft of the drive gear and the rotation shaft of the second paddle being concentrically connected to each other, and the rotation shaft of the second paddle freely rotating with respect to the rotation shaft of the drive gear.

7. The toner cartridge according to claim 6, wherein the first paddle includes a hook which is integrally formed with the first paddle and receives the rotation shaft of the second paddle so as to enable free rotation of the first paddle.

8. The toner cartridge according to claim 1, wherein the elastic member is a tension spring mounted at one side with respect to the rotation center of the first paddle and the second paddle.

9. An electrophotographic image forming apparatus including a detachable toner cartridge, wherein the toner cartridge comprises:
a hopper for storing toner therein;
a stirring means comprising a first paddle connected to a driving source and adapted to rotate in the hopper, and a second paddle connected to the first paddle by means of an elastic member, the stirring means being adapted to stir the toner in the hopper by the first paddle and the second paddle; and
a detection means comprising an encoder having a first slit and a second slit formed thereon for transmitting light therethrough, the second slit having a width different from that of the first slit, an encoder gear connected to the second paddle for driving the encoder, and a sensor 590 mounted at a sensor reference position for outputting a first signal corresponding to the first slit and a second signal corresponding to the second slit,
whereby the sensor detects a time delay of the second signal with respect to the first signal to measure the residual amount of the toner.

10. A toner cartridge comprising:
a hopper for storing toner therein;
a stirring means comprising a first paddle connected to a driving source and adapted to rotate in the hopper, and a second paddle connected to the first paddle by means of an elastic member, the stirring means being adapted to stir the toner in the hopper by the first paddle and the second paddle; and
a detection means comprising an encoder having a first slit and a second slit formed thereon for transmitting light therethrough, the second slit having a width different from that of the first slit, an encoder gear connected to the second paddle for driving the encoder, and a sensor mounted at a sensor reference position for outputting a first signal corresponding to the first slit and a second signal corresponding to the second slit,
whereby the sensor detects a time delay of the second signal with respect to the first signal to measure the residual amount of the toner.

11. The toner cartridge according to claim 10, wherein the detection means further comprises an encoder spring, the encoder rotates when an intermittent gear formed in the encoder gear meshes with an intermittent gear formed in the encoder and returns to its initial position when the mesh engagement between the intermittent gears of the encoder gear and the encoder is released.

12. The toner cartridge according to claim 11, wherein the detection means further comprises a light shielding plate for blocking the first and second slits so as to prevent the first and second slits from being detected by the sensor over a section where the encoder elastically returns to its initial position.

13. The toner cartridge according to claim 12, wherein the encoder is formed in a semicircular strip shape having the first and second slits formed thereon, and has a rotation center different from that of the encoder gear.

14. The toner cartridge according to claim 10, wherein the rotation center of the first paddle is a rotation shaft of a drive gear connected to the driving source, and the rotation center of the second paddle is a rotation shaft of the second paddle, the rotation shaft of the drive gear and the rotation shaft of the second paddle being concentrically connected to each other, and the rotation shaft of the second paddle freely rotating with respect to the rotation shaft of the drive gear.

15. The toner cartridge according to claim 10, wherein the radius of rotation of the front end of the second paddle is larger than that of the first paddle, and the elastic member is a tension spring mounted at one side with respect to the rotation center of the first paddle and the second paddle, the first paddle, the second paddle and the elastic member being mounted inside the hopper.

16. The toner cartridge according to claim 14, wherein the first paddle and the second paddle rotate while maintaining an initial relative position between the first paddle and the second paddle connected by means of the elastic member when there is no toner residual amount in the hopper.

17. The toner cartridge according to claim 10, wherein the output period of the first signal corresponds to the rotation period of the first paddle.

18. The toner cartridge according to claim 17, wherein the time delay of the second signal with respect to the first signal decreases as the toner residual amount decreases.

19. The toner cartridge according to claim 10, wherein the first paddle is provided with a first contact portion and the second paddle is provided with a second contact portion,
wherein if the toner residual amount is above a predetermined value, the second paddle stirs the toner in the hopper by the contact between the first contact portion and the second contact portion,
wherein if the toner residual amount is below the predetermined value, the second paddle stirs the toner in the hopper by the restoring force of the elastic member,
wherein if the toner residual amount is above the predetermined value, the time delay maintains an upper limit value, and
wherein if the toner residual amount is below the predetermined value, the time delay decreases as the toner residual amount decreases.

20. The toner cartridge according to claim 19, wherein the following proportional expression is established:
The rotation period of the first paddle: the upper limit value of the time delay=360°: the spacing angle between the first contact portion and the second contact portion.

21. A toner cartridge comprising:
a developing roller for allowing an electrostatic latent image formed in advance on a photosensitive body to be developed as a toner image;
a supply roller for supplying the toner to the developing roller;
a stirring means for stirring the toner stored in the hopper to convey the stirred toner to the supply roller;
an auxiliary stirring means comprising an auxiliary stirring roller disposed between the stirring means and the supply roller for re-stirring the toner being fed from the stirring means, a ratchet for rotating the auxiliary stirring roller, and a pawl movement member including a pawl adapted to tooth-engage with the ratchet so that it is linearly moved together with the pawl to rotate the ratchet,
wherein the pawl movement member is linearly be moved by being connected to the stirring means to cause the auxiliary stirring roller to be driven.

22. The toner cartridge according to claim 21, wherein the pawl movement member is linearly moved inside the hopper.

23. The toner cartridge according to claim 22, wherein the pawl movement member comprises a protruding cam adapted to rotate together with at least one of paddles of the stirring means, a first slider adapted to be intervened by the protruding cam to linearly move the pawl movement member in a first direction to cause the pawl to be pushed to rotate the ratchet, and a second slider adapted to be intervened by the protruding cam to linearly move the pawl movement member in a second direction opposite to the first direction to cause the engagement of the pawl and the ratchet to be released.

24. The toner cartridge according to claim 23, wherein the pawl movement member further comprises a boss serving as a rotation shaft of the protruding cam and a slot for allowing the boss to be movably fit thereto.

25. The toner cartridge according to claim 24, wherein the stirring means comprises a first paddle connected to a driving source and adapted to rotate in the hopper, a second paddle adapted to receive a load contact torque larger than a load contact torque acting on the first paddle, and an elastic member for elastically connecting the second paddle to the first paddle, and
wherein the boss is a rotation shaft of the second paddle to which the second paddle is fixed.

26. The toner cartridge according to claim 24, further comprising a detection means comprising an encoder having a first slit and a second slit formed thereon for transmitting light therethrough, the second slit having a width different from that of the first slit, an encoder gear connected to the second paddle for driving the encoder, and a sensor mounted at a sensor reference position for outputting a first signal corresponding to the first slit and a second signal corresponding to the second slit,
whereby the sensor detects a time delay of the second signal with respect to the first signal to measure the residual amount of the toner.

27. A toner cartridge comprising:
a developing roller for allowing an electrostatic latent image formed in advance on a photosensitive body to be developed as a toner image;
a supply roller for supplying the toner to the developing roller;
a stirring means for stirring the toner stored in the hopper to convey the stirred toner to the supply roller;
an auxiliary stirring means comprising an auxiliary stirring roller disposed between the stirring means and the supply roller for re-stirring the toner being fed from the stirring means, a roller gear for rotating the auxiliary stirring roller, and an intermittent gear for intermittently driving the roller gear,
wherein the intermittent gear rotates by being connected to the stirring means to cause the auxiliary stirring roller to be driven.

28. The toner cartridge according to claim 27, wherein the intermittent gear rotates inside hopper.

29. The toner cartridge according to claim 28, wherein the auxiliary stirring means further comprises at least one relay gear disposed between the roller gear and the intermittent gear.

30. The toner cartridge according to claim 29, wherein the stirring means comprises a first paddle connected to a driving source and adapted to rotate in the hopper, a second paddle adapted to receive a load contact torque larger than a load contact torque acting on the first paddle, and an elastic member for elastically connecting the second paddle to the first paddle, and
wherein the intermittent gear is fixed to a rotation shaft of the second paddle to which the second paddle is fixed so that the intermittent gear rotates together with the second paddle.

31. The toner cartridge according to claim 30, further comprising a detection means comprising an encoder having a first slit and a second slit formed thereon for transmitting light therethrough, the second slit having a width different from that of the first slit, an encoder gear connected to the second paddle for driving the encoder, and a sensor mounted at a sensor reference position for outputting a first signal corresponding to the first slit and a second signal corresponding to the second slit,
whereby the sensor detects a time delay of the second signal with respect to the first signal to measure the residual amount of the toner.

32. A toner cartridge comprising:
a developing roller for allowing an electrostatic latent image formed in advance on a photosensitive body to be developed as a toner image;
a supply roller for supplying the toner to the developing roller;
a stirring means for stirring the toner stored in the hopper to convey the stirred toner to the supply roller;
an auxiliary stirring means comprising an auxiliary stirring roller disposed between the stirring means and the supply roller for re-stirring the toner being fed from the stirring means, a first link for rotating the auxiliary stirring roller, a second link connected at one side thereof to the first link and having an eccentric cam insertion portion formed at the other side thereof, and an eccentric cam rotatably inserted into the eccentric cam inserting portion,
wherein the eccentric cam rotates by being connected to the stirring means to cause the auxiliary stirring roller to be driven.

33. The toner cartridge according to claim 32, wherein the first link, the second link and the eccentric cam are mounted inside the hopper

34. The toner cartridge according to claim 33 wherein the stirring means comprises a first paddle connected to a driving source and adapted to rotate in the hopper, a second paddle adapted to receive a load contact torque larger than a load contact torque acting on the first paddle, and an elastic member for elastically connecting the second paddle to the first paddle, and
wherein the eccentric cam is eccentrically fixed to a rotation shaft of the second paddle to which the second paddle is fixed so that the eccentric cam rotates together with the second paddle.

35. The toner cartridge according to claim 34, further comprising a detection means comprising an encoder having a first slit and a second slit formed thereon for transmitting light therethrough, the second slit having a width different from that of the first slit, an encoder gear connected to the second paddle for driving the encoder, and a sensor mounted at a sensor reference position for outputting a first signal corresponding to the first slit and a second signal corresponding to the second slit,
whereby the sensor detects a time delay of the second signal with respect to the first signal to measure the residual amount of the toner.

36. A toner cartridge comprising:
a developing roller for allowing an electrostatic latent image formed in advance on a photosensitive body to be developed as a toner image;
a supply roller for supplying the toner to the developing roller;
a stirring means for stirring the toner stored in the hopper to convey the stirred toner to the supply roller; and
an auxiliary stirring means comprising an auxiliary stirring wire portion disposed between the stirring means and the supply roller for re-stirring the toner being fed from the stirring means, and a wire roller gear for rotating the auxiliary stirring wire portion,
wherein the auxiliary stirring wire portion comprises an auxiliary stirring wire stirrer, wherein the auxiliary stirring wire stirrer comprises an auxiliary stirring wire body connector connected to the wire roller gear, and an auxiliary stirring wire body connected to the auxiliary stirring wire body connector, the lengthwise central axis of the auxiliary stirring wire body being spaced apart from the rotation center of the wire roller gear, so that the auxiliary stirring wire body re-stirs the toner.

37. The toner cartridge according to claim 36 wherein the auxiliary stirring wire portion 940 further comprises an auxiliary stirring wire connector 920 connected rotatably to the wire roller gear 910, the auxiliary stirring wire connector 920 comprising an auxiliary stirring wire portion rotation stopper 923 for preventing the relative movement between the auxiliary stirring wire stirrer and the wire roller gear.

38. The toner cartridge according to claim 36 wherein the stirring means comprises a first paddle connected to a driving source and adapted to rotate in the hopper, a second paddle adapted to receive a load contact torque larger than a load contact torque acting on the first paddle, and an elastic member for elastically connecting the second paddle to the first paddle, and
wherein the wire roller gear is fixed to a rotation shaft of the second paddle to which the second paddle is fixed so that the wire roller gear rotates together with the second paddle.

39. The toner cartridge according to claim 38, further comprising a detection means comprising an encoder having a first slit and a second slit formed thereon for transmitting light therethrough, the second slit having a width different from that of the first slit, an encoder gear connected to the second paddle for driving the encoder, and a sensor mounted at a sensor reference position for outputting a first signal corresponding to the first slit and a second signal corresponding to the second slit,
whereby the sensor detects a time delay of the second signal with respect to the first signal to measure the residual amount of the toner.
